(19) United States
(12) Patent Application Publication
(10) Pub. No.: US 2025/0291296 A1
(43) Pub. Date: Sep. 18, 2025

(54) IMAGE FORMING DEVICE

(71) Applicant: BROTHER KOGYO KABUSHIKI KAISHA, Nagoya (JP)

(72) Inventors: Shota SHINOYA, Nisshin (JP); Tomoyuki MIZUNO, Nagoya (JP); Tatsuya KOYAMA, Toyoake (JP); Yusuke MIZUNO, Nagoya (JP); Masaaki WAKIZAKA, Nagoya (JP); Kazushi SHUMIYA, Konan (JP); Koya MORIMOTO, Nagoya (JP)

(73) Assignee: BROTHER KOGYO KABUSHIKI KAISHA, Nagoya (JP)

(21) Appl. No.: 19/220,854

(22) Filed: May 28, 2025

Related U.S. Application Data
(63) Continuation of application No. PCT/JP2023/039999, filed on Nov. 7, 2023.

(30) Foreign Application Priority Data
Nov. 30, 2022 (JP) 2022-192447
Nov. 30, 2022 (JP) 2022-192477

(51) Int. Cl. G03G 15/00; G03G 15/20; G03G 21/16

(52) U.S. Cl. CPC G03G 15/6582; G03G 15/2064; G03G 15/5029; G03G 15/6552; G03G 21/1633; G03G 2215/00556; G03G 2215/00734; G03G 2215/00814

(57) ABSTRACT

An image forming device includes a device main body including a conveying path of a sheet, a fixing unit configured to fix an image formed on the sheet onto the sheet, the fixing unit including a heating rotor, and a pressure rotor in which a nip is formed between the heating rotor and the pressure rotor, a first discharge roller located at a downstream side of the fixing unit in a conveying direction of the sheet along the conveying path, and configured to convey the sheet, a second discharge roller located at a downstream side of the first discharge roller in the conveying direction, and configured to discharge the sheet conveyed by the first discharge roller to an outside of the device main body.

### REFERENCE TO RELATED APPLICATIONS

This is a continuation application of International Application No. PCT/JP2023/039999 filed on Nov. 7, 2023, which claims priority from Japanese Patent Application No. 2022-192447 filed on Nov. 30, 2022 and Japanese Patent Application No. 2022-192477 filed on Nov. 30, 2022. The entire contents of the aforementioned applications are incorporated herein by reference.

### BACKGROUND ART

A related art discloses an image forming device in which a sheet fed from an image forming unit is conveyed to a position of a cutter, and the sheet is cut in a direction perpendicular to a conveying direction at a center portion of the sheet in the conveying direction. The image forming device includes a sheet detection unit, and controls a branch guide in response to detection of the sheet by the sheet detection unit, and separately discharges the cut sheet onto a first discharge tray and a second discharge tray.

### SUMMARY

An image forming device includes a device main body including a conveying path of a sheet; a fixing unit configured to fix an image formed on the sheet onto the sheet, the fixing unit including: a heating rotor; and a pressure rotor in which a nip is formed between the heating rotor and the pressure rotor,; a first discharge roller located at a downstream side of the fixing unit in a conveying direction of the sheet along the conveying path, and configured to convey the sheet; a second discharge roller located at a downstream side of the first discharge roller in the conveying direction, and configured to discharge the sheet conveyed by the first discharge roller to an outside of the device main body; a cutter located at a cutter position and configured to cut the sheet in a cutting direction intersecting the conveying direction, the cutter position being a position between the first discharge roller and the second discharge roller in the conveying direction; and a first sensor configured to detect whether the sheet is present at a first detection position between the first discharge roller and the second discharge roller in the conveying direction.

### BRIEF DESCRIPTION OF DRAWINGS

FIG. 1 is a cross-sectional view showing a schematic configuration of a monochrome laser printer.

FIG. 2 is a perspective view showing a schematic configuration of a cutter included in the monochrome laser printer of FIG. 1.

FIG. 3 is a block diagram showing a control configuration of the monochrome laser printer of FIG. 1.

FIG. 4A is a diagram showing a cutting position of a sheet.

FIG. 4B is a diagram showing the sheet cut at the cutting position.

FIG. 5A is a diagram showing operations of a sheet detection sensor in a cover open state.

FIG. 5B is a diagram showing operations of a sheet detection sensor in a cover closed state and a sheet undetected state.

FIG. 5C is a diagram showing operations of a sheet detection sensor in the cover closed state and a sheet detected state.

FIG. 6 is a flowchart showing a procedure of a printing process in the monochrome laser printer of FIG. 1.

FIG. 7 is a flowchart showing a detailed procedure of a sheet printing and cutting process included in the printing process of FIG. 6.

FIG. 8 is a flowchart showing a detailed procedure of a sheet conveying step number determination process based on set sheet length included in the sheet printing and cutting process of FIG. 7.

FIG. 9 is a flowchart showing a detailed procedure of a sheet conveying process to cutter position included in the sheet printing and cutting process of FIG. 7.

FIG. 10 is a flowchart showing a detailed procedure of a sheet cutting process included in the sheet printing and cutting process of FIG. 7.

FIG. 11 is a flowchart showing a detailed procedure of an error stopping process in response to sheet pulled-out detection included in the sheet cutting process of FIG. 10.

FIG. 12 is a flowchart showing a detailed procedure of an error stopping process in response to JAM included in the sheet printing and cutting process of FIG. 7.

FIG. 13 is a flowchart showing a procedure of a cover state determination process in the monochrome laser printer of FIG. 1.

FIG. 14 is a flowchart showing a detailed procedure of a sheet printing and cutting process in a monochrome laser printer.

FIG. 15 is a flowchart showing a detailed procedure of a sheet conveying step number determination process based on measured sheet length included in the sheet printing and cutting process of FIG. 14.

FIG. 16 is a diagram for illustrating the sheet conveying step number determination process based on measured sheet length of FIG. 15.

FIG. 17 is a cross-sectional view showing a schematic configuration of a monochrome laser printer.

FIG. 18A is a diagram for illustrating a problem that occurs when cutting a shrinking sheet and a countermeasure for the problem.

FIG. 18B is a diagram for illustrating a problem that occurs when cutting a shrinking sheet and a countermeasure for the problem.

FIG. 18C is a diagram for illustrating a problem that occurs when cutting a shrinking sheet and a countermeasure for the problem.

FIG. 19 is a flowchart showing a detailed procedure of a sheet printing and cutting process included in the printing process of FIG. 6.

FIG. 20 is a flowchart showing a detailed procedure of a sheet conveying process to cutter position included in the printing process of FIG. 6.

FIG. 21 is a flowchart showing a detailed procedure of a sheet cutting process included in the printing process of FIG. 6.

FIG. 22A is a diagram for illustrating the sheet conveying process to cutter position of FIG. 20.

FIG. 22B is a diagram for illustrating the sheet conveying process to cutter position of FIG. 20.

FIG. 23A is a diagram continued from FIGS. 22A and 22B for illustrating the sheet conveying process to cutter position of FIG. 20.

FIG. 23B is a diagram continued from FIGS. 22A and 22B for illustrating the sheet conveying process to cutter position of FIG. 20.

FIG. 24 is a cross-sectional view showing a schematic configuration of a monochrome laser printer.

FIG. 25 is a flowchart showing a procedure of a sheet conveying process to cutter position of the monochrome laser printer of FIG. 24.

FIG. 26 is a diagram for illustrating the sheet conveying process to cutter position of FIG. 25.

### DESCRIPTION

Hereinafter, embodiments of the present application will be described in detail with reference to the drawings.

### First Embodiment

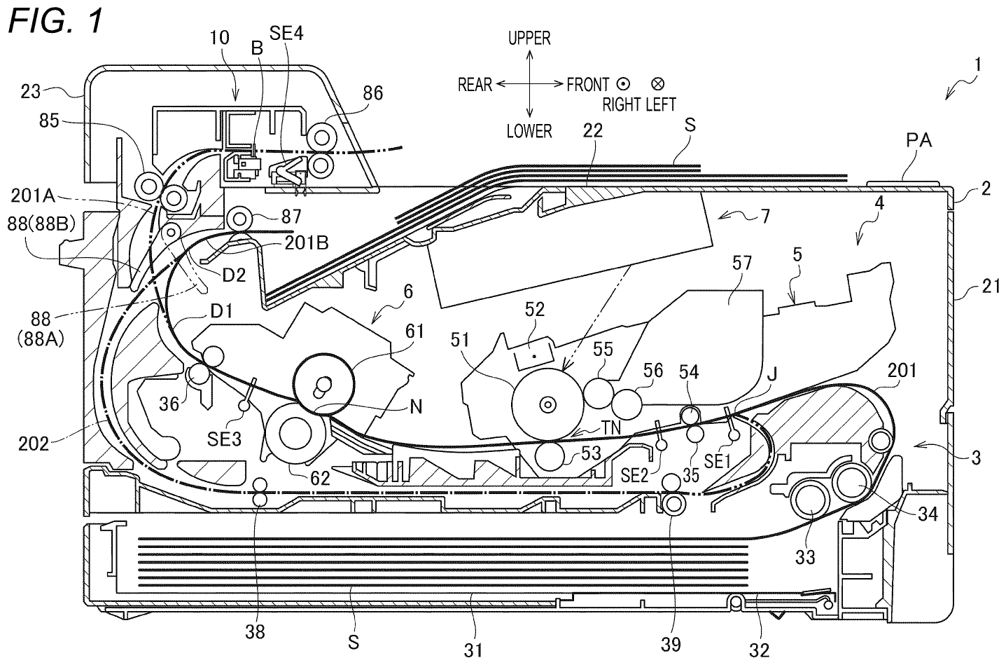

FIG. 1 is a cross-sectional view showing a schematic configuration of a monochrome laser printer 1 according to a first embodiment of the present application. The monochrome laser printer 1 is an example of an image forming device. Hereinafter, the monochrome laser printer 1 is abbreviated as a printer 1. The printer 1 includes a device main body 2, a conveying unit 3, an image forming unit 4, a fixing unit 6, a cutter 10, and an operation panel PA. Hereinafter, for convenience of description, an upper-lower direction and a front-rear direction of the printer 1 are defined, as indicated by arrows in FIG. 1. This side of the paper is defined as the left, and the other side of the paper is defined as the right.

The device main body 2 includes a front cover 21, a supply tray 31, a discharge tray 22, a conveying path 201, and a re-conveying path 202. The front cover 21 is attached to a front surface of the device main body 2 in an openable and closable manner. The supply tray 31 is detachably attached to a lower portion of the device main body 2. A sheet S is placed on the supply tray 31. The sheet S is a standard sheet such as an A4 size sheet. The sheet S is, for example, a paper medium such as plain paper or thick paper, but the present invention is not limited thereto, and the sheet S may be an OHP film. The discharge tray 22 is provided on an upper portion of the device main body 2, and the sheet S on which an image is formed is placed on the discharge tray 22.

The conveying path 201 is a path for conveying the sheet S placed on the supply tray 31 along a conveying direction toward the discharge tray 22 via the image forming unit 4. The conveying path 201 branches from a first branch position D1 into a first discharge path 201A and a second discharge path 201B. Therefore, the sheet S conveyed via the image forming unit 4 includes one discharged to the discharge tray 22 through the first discharge path 201A and one discharged to the discharge tray 22 through the second discharge path 201B.

The re-conveying path 202 is a path for reversing the sheet S having an image formed on one surface thereof and conveying the sheet S to the image forming unit 4 again. The re-conveying path 202 is branched from the conveying path 201 at a second branch position D2, and joins the conveying path 201 at a junction position J on an upstream side of a pre-registration sensor SE1 in the conveying direction.

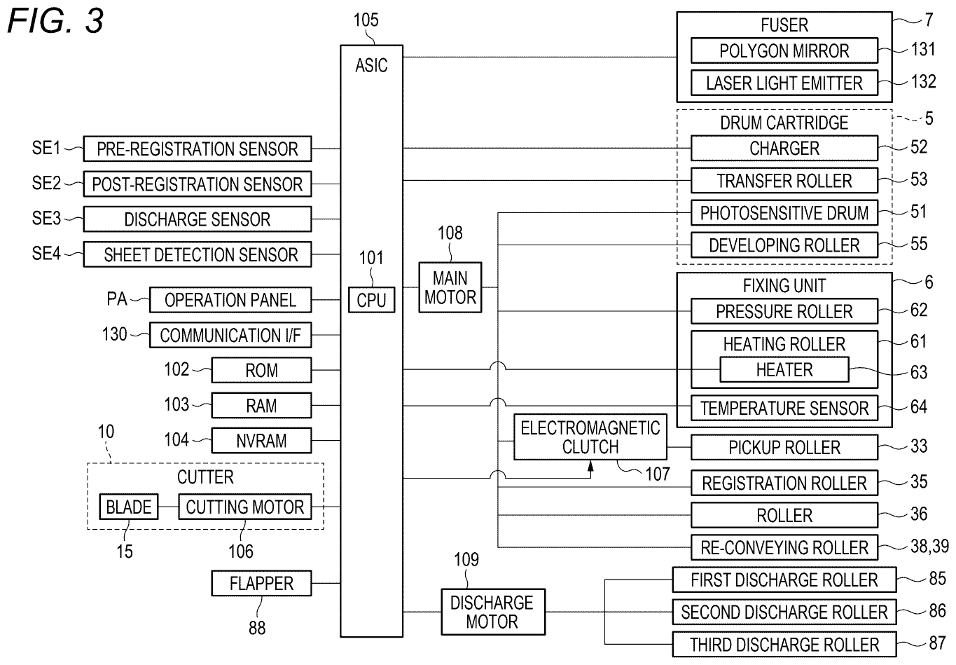

The conveying unit 3 includes a pickup roller 33, a separation roller 34, a registration roller 35, a roller 36, a first discharge roller 85, a second discharge roller 86, a third discharge roller 87, a flapper 88, re-conveying rollers 38 and 39, a main motor 108 (see FIG. 3), and a discharge motor 109 (see FIG. 3). A plurality of conveying rollers include the pickup roller 33, the separation roller 34, the registration roller 35, the roller 36, the first discharge roller 85, the second discharge roller 86, and the third discharge roller 87. The printer I uses the plurality of conveying rollers to convey the sheet S along the conveying path 201.

The pickup roller 33 is configured to pick up the sheet S in the supply tray 31 pushed upward by a sheet pressing plate 32, and convey the sheet S toward the conveying path 201. The separation roller 34 is configured to separate a plurality of sheets S picked up by the pickup roller 33 one by one.

The registration roller 35 is disposed at an upstream side of the image forming unit 4 in the conveying path 201. After aligning a direction of a leading end of the sheet S, the registration roller 35 conveys the sheet S toward the image forming unit 4. The conveying direction where the registration roller 35 conveys the sheet is a direction from the front toward the rear. The roller 36 is configured to convey the sheet S passing through the fixing unit 6 toward the first discharge roller 85 or the third discharge roller 87. The conveying direction where the fixing unit 6 and the roller 36 convey the sheet is a direction from the front toward the rear and is a diagonally upward direction.

The first discharge roller 85 and the second discharge roller 86 are disposed on the first discharge path 201A. The first discharge roller 85 and the second discharge roller 86 are a pair of rollers including a driving roller and a driven roller. The first discharge roller 85 is disposed at a position on an upstream side of a cutter position B where the cutter 10 is disposed, and the second discharge roller 86 is disposed at a position on a downstream side of the cutter position B.

The first discharge roller 85 and the second discharge roller 86 is configured to perform forward rotation to discharge the sheet S to the discharge tray 22. The forward rotation is rotation for conveying the sheet S in the conveying direction, and corresponds to rotation in a counterclockwise direction with a left-right direction of the device main body 2 as an axis. The conveying direction where the first discharge roller 85 conveys the sheet is a direction from the rear to the front and toward an upper side. The conveying direction where the second discharge roller 86 conveys the sheet S is a direction from the rear toward the front.

On the other hand, the third discharge roller 87 is disposed on the second discharge path 201B. The third discharge roller 87 is also a roller pair including a driving roller and a driven roller. The third discharge roller 87 is configured to perform the forward rotation to discharge the sheet S to the discharge tray 22. The third discharge roller 87 is configured to perform reverse rotation, which is rotation in a direction opposite to the forward rotation, to convey the sheet S to the re-conveying path 202. The reverse rotation is rotation in which the sheet S is conveyed in a direction opposite to the conveying direction, and corresponds to rotation in a clockwise direction with the left-right direction of the device main body 2 as the axis. That is, the conveying direction where the third discharge roller 87 performs the forward rotation to convey the sheet is a direction from the rear toward the front, and the direction where the third discharge roller 87 performs the reverse rotation to convey the sheet S is a direction from the front toward the rear.

The re-conveying rollers 38 and 39 are disposed on the re-conveying path 202. The re-conveying rollers 38 and 39 is configured to convey the sheet S conveyed to the re-conveying path 202 toward the image forming unit 4. By re-conveying the sheet S having an image formed on one surface thereof toward the image forming unit 4 through the re-conveying path 202 by the re-conveying rollers 38 and 39, the image can be formed on both sides of the sheet S. That is, the conveying direction where the re-conveying rollers 38 and 39 convey the sheet is a direction from the rear toward the front.

The image forming unit 4 forms an image on the sheet S and is accommodated in the device main body 2. The image forming unit 4 includes a drum cartridge 5 and a laser unit 7. The drum cartridge 5 includes a photosensitive drum 51, a toner container 57, a supply roller 56, a developing roller 55, a charger 52, a transfer roller 53, and a pinch roller 54. The drum cartridge 5 can be removed from the device main body 2 by opening the front cover 21. The pinch roller 54 of the drum cartridge 5 faces the registration roller 35. The pinch roller 54 is configured to rotate by following rotation of the registration roller 35 and convey the sheet S together with the registration roller 35.

The photosensitive drum 51 is configured to rotate in the clockwise direction based on a driving force transmitted from the main motor 108 (see FIG. 3) to convey the sheet S in the conveying direction. In the photosensitive drum 51, the forward rotation, which is the rotation for conveying the sheet S in the conveying direction, is the clockwise direction. The toner container 57 contains toner. The supply roller 56 is configured to supply the toner in the toner container 57 to the developing roller 55. The charger 52 is a scorotron charger and uniformly charges a surface of the photosensitive drum 51. The charger 52 may be a charging roller.

The transfer roller 53 is disposed at a position facing the photosensitive drum 51. A transfer nip TN is formed between the transfer roller 53 and the photosensitive drum 51 in the conveying path 201. A transfer belt may be used instead of the transfer roller 53.

The device main body 2 includes the laser unit 7 at an upper portion inside the device main body 2. The laser unit 7 includes a polygon mirror 131 (see FIG. 3), a laser light emitter 132 (see FIG. 3), a lens (not shown), a reflecting mirror (not shown), and the like. In the laser unit 7, a laser beam (see a dot-dashed line in FIG. 1) based on image data emitted from the laser light emitter 132 is scanned at high speed on the surface of the photosensitive drum 51 to expose the surface of the photosensitive drum 51.

The surface of the photosensitive drum 51 is exposed to light by the laser unit 7, and an electrostatic latent image based on the image data is formed on the surface. The developing roller 55 is configured to supply the toner to the electrostatic latent image formed on the surface of the photosensitive drum 51 to form a toner image on the surface of the photosensitive drum 51.

A transfer voltage is applied to the transfer roller 53 from a voltage application unit (not shown). The transfer roller 53 is configured to convey the sheet S to and from the photosensitive drum 51, thereby transferring the toner image formed on the surface of the photosensitive drum 51 to the sheet S passing through the transfer nip TN. In this way, the image is formed on the sheet S.

The fixing unit 6 is disposed at a downstream side of the image forming unit 4 in the conveying path 201. The fixing unit 6 includes a heating roller 61, a pressure roller 62, a heater 63 (see FIG. 3), and a temperature sensor 64 (see FIG. 3). The heating roller 61 is an example of a heating rotor, and is configured to heat the sheet S. The pressure roller 62 is an example of a pressure rotor, and is configured to form a nip N between the pressure roller 62 and the heating roller 61 to pressurize the sheet S. The pressure roller 62 is configured to rotate in the counterclockwise direction by the driving force of the main motor 108. In the pressure roller 62, the forward rotation, which is the rotation for conveying the sheet S in the conveying direction, is the counterclockwise direction. Accordingly, the pressure roller 62 is a driving roller, and the heating roller 61 is a driven roller. Conversely, the heating roller 61 may be a driving roller that rotates in the clockwise direction by the driving force of the main motor 108, and the pressure roller 62 may be a driven roller.

The heater 63 is, for example, a halogen heater, and is configured to heat the heating roller 61. The temperature sensor 64 is provided in the vicinity of the heating roller 61 and is configured to detect a temperature of the heating roller 61. The temperature sensor 64 is configured to output a signal corresponding to the detected temperature to a CPU 101 (see FIG. 3).

The fixing unit 6 heats the sheet S by the heating roller 61 and rotates the pressure roller 62, so that the sheet S is conveyed while being pressurized by the heating roller 61 and the pressure roller 62, and thus, the image formed on the sheet S by the image forming unit 4 is fixed onto the sheet S.

The fixing unit 6 includes the heating roller 61, the pressure roller 62, and the heater 63, but is not limited thereto. For example, the fixing unit 6 may include a heater, a nip plate configured to receive radiant heat from the heater, a heating belt configured to rotate around the nip plate, and a pressure roller. The fixing unit 6 may include a substrate on which a heat generating pattern is formed, a belt configured to rotate around the substrate, and a pressure roller, and the substrate may be in contact with the belt. The fixing unit 6 may include a heating roller, a heater, and a pressure belt.

The cutter 10 is disposed at the cutter position B between the first discharge roller 85 and the second discharge roller 86 in the first discharge path 201A. As described later, the printer 1 stops the rotation of the first discharge roller 85 and the second discharge roller 86 such that the cutting position on the sheet S reaches the cutter position B. In a state where the rotation of the first discharge roller 85 and the second discharge roller 86 is stopped, the printer 1 cuts the sheet S at the cutter position B by using the cutter 10.

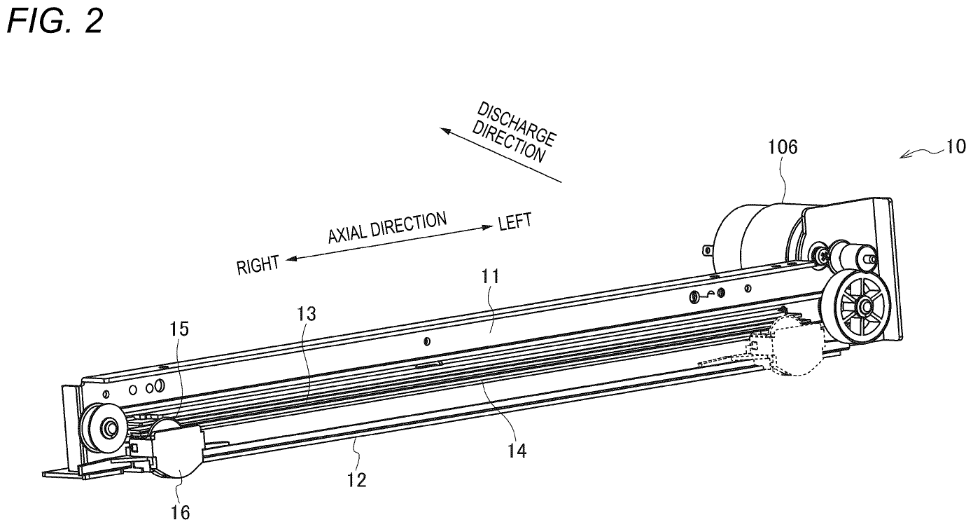

FIG. 2 shows a schematic configuration of the cutter 10. As shown in FIG. 2, the cutter 10 includes a cutter frame 11, a slide rail 12, a fixing blade 13, a sheet passing portion 14, a moving blade 15, a slide holder 16, and a cutting motor 106. The cutter frame 11 extends in an axial direction. The slide rail 12 is a rail formed on the cutter frame 11 and extending in the axial direction. The fixing blade 13 is a flat blade fixed to the cutter frame 11 and extending in the axial direction. The sheet passing portion 14 is a space formed on the cutter frame 11 and allowing the sheet S to pass. In the present embodiment, the sheet passing portion 14 is formed between the slide rail 12 and the fixing blade 13. The moving blade 15 is a circular plate-shaped blade and is rotatably fixed to the slide holder 16. The cutting motor 106 is, for example, a DC motor with an encoder, and the encoder (not shown) is configured to output a signal related to rotation of the DC motor to the CPU 101.

The slide holder 16 is engaged with the slide rail 12 and is attached to the cutter frame 11 in a manner of slidably moving along the slide rail 12. When the cutting motor 106 performs the forward rotation, the slide holder 16 slides from one side to the other side in the axial direction, and when the cutting motor 106 performs the reverse rotation, the slide holder 16 slides from the other side to one side in the axial direction. The slide holder 16 is movable from an initial position indicated by a solid line to a cutting completion position indicated by a dashed line in FIG. 2. If the slide holder 16 moves to the cutting completion position along the slide rail 12 when the sheet S is at the cutter position B, one sheet S is sandwiched between the fixing blade 13 and the moving blade 15 and then cut into two sheets. After the sheet S is cut, the printer 1 rotates the first discharge roller 85 and the second discharge roller 86 for a predetermined time to discharge the cut sheet S cut into two sheets to the discharge tray 22.

The printer 1 is configured to cut an A4 size sheet S and a letter size sheet S at centers of the sheets in the conveying direction by the cutter 10. That is, a length of the conveying path 201 from the nip N to the cutter position B in FIG. 1 is designed to be longer than half (148.5 mm) a dimension (297 mm) of the A4 size sheet S in the conveying direction. According to this configuration, when the A4 size sheet S or the letter size sheet S is cut at the cutter position B in a state where the rotation of the first discharge roller 85 and the second discharge roller 86 is stopped, a trailing end of the sheet S passes through the nip N of the fixing unit 6. If the rotation of the first discharge roller 85 and the second discharge roller 86 is stopped in order to cut the sheet S at the cutter position B in a state where the sheet S is nipped by the nip N of the fixing unit 6, it is necessary to stop the rotation of the pressure roller 62. However, if the rotation of the pressure roller 62 is stopped in the state where the sheet S is nipped by the nip N of the fixing unit 6, heat is locally applied to the same location of the sheet S from the heating roller 61. Therefore, when the sheet S is cut at the cutter position B in the state where the rotation of the first discharge roller 85 and the second discharge roller 86 is stopped, the trailing end of the sheet S needs to pass through the nip N of the fixing unit 6.

Furthermore, the length of the conveying path 201 from the nip of the roller 36 to the cutter position B in FIG. 1 is designed to be longer than half (148.5 mm) the dimension (297 mm) of the A4 size sheet S in the conveying direction. According to this configuration, when the sheet S is cut at the cutter position B in the state where the rotation of the first discharge roller 85 and the second discharge roller 86 is stopped, the trailing end of the sheet S passes through the nip of the roller 36. When the sheet S is cut at the cutter position B in the state where the rotation of the first discharge roller 85 and the second discharge roller 86 is stopped, if the nip of the roller 36 or the pressure roller 62 rotates with the sheet sandwiched, the sheet S may be bent in a bellows shape between the first discharge roller 85 and the roller 36. Therefore, according to the above configuration, by only stopping the rotation of the first discharge roller 85 and the second discharge roller 86 without stopping the rotation of the roller 36 and the fixing unit 6, the sheet is not bent in a bellows shape, and the sheet can be stopped at the cutting position.

A length of the second discharge path 201B is designed to be shorter than a length of the first discharge path 201A. That is, the second discharge roller 86 is positioned on a front side of the third discharge roller 87. This is because, when the sheet S after the image formation is not cut, the sheet S is discharged quickly to an outside of the device main body 2.

Next, a control configuration of the printer 1 will be described with reference to FIG. 3. As shown in FIG. 3, the printer 1 further includes an ASIC 105, a ROM 102, a RAM 103, an NVRAM 104, a post-registration sensor SE2, a discharge sensor SE3, a sheet detection sensor SE4, and a communication interface (I/F) 130.

The CPU 101 is mounted on the ASIC 105. The CPU 101 is an example of a controller, and is configured to perform an overall control on units of the printer 1. The ASIC 105 is electrically connected to the ROM 102, the RAM 103, the NVRAM 104, the cutting motor 106, the flapper 88, an electromagnetic clutch 107, the main motor 108, the discharge motor 109, the pre-registration sensor SE1, the post-registration sensor SE2, the discharge sensor SE3, the sheet detection sensor SE4, the operation panel PA, the communication I/F 130, the drum cartridge 5, the fixing unit 6, and the laser unit 7.

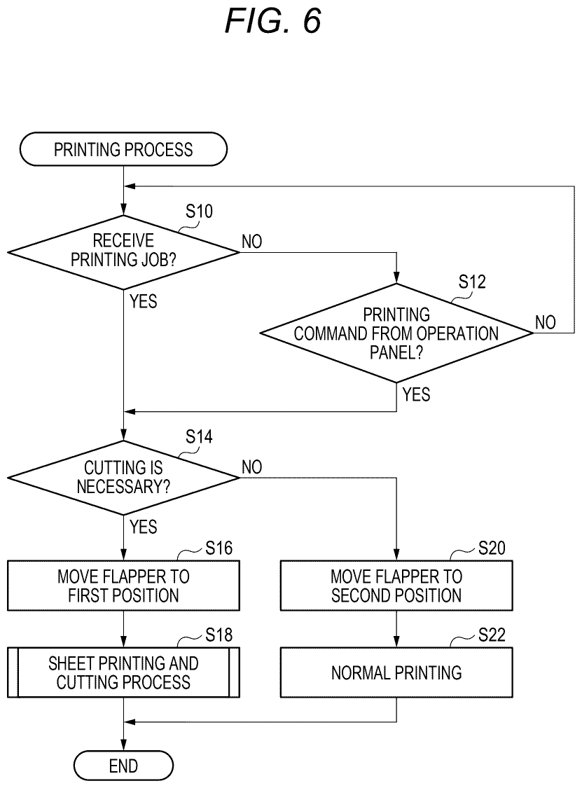

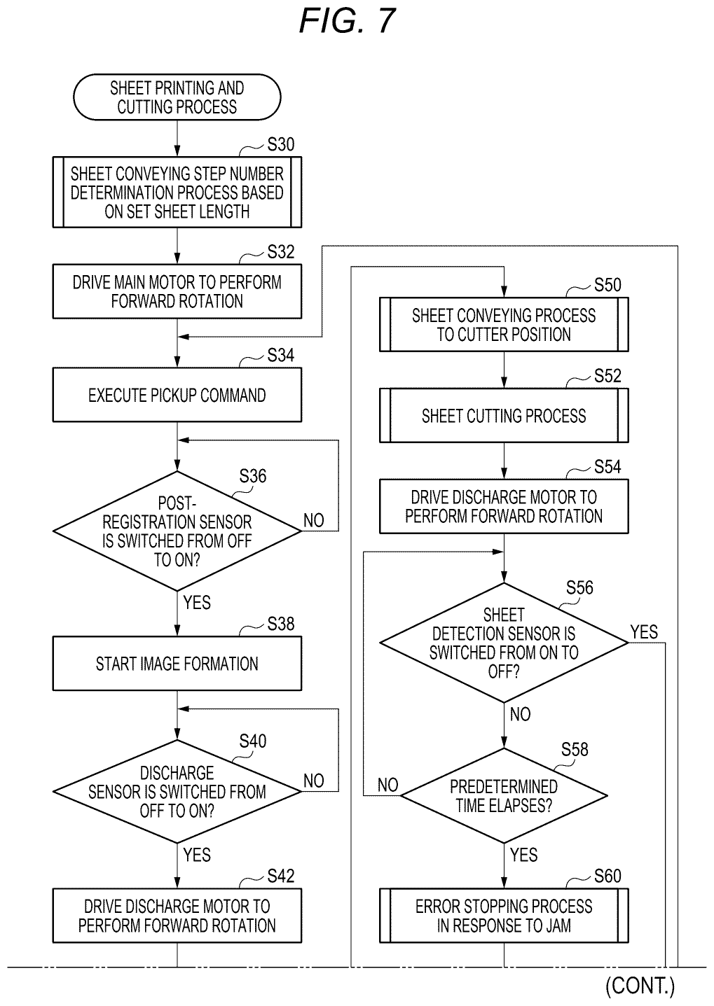

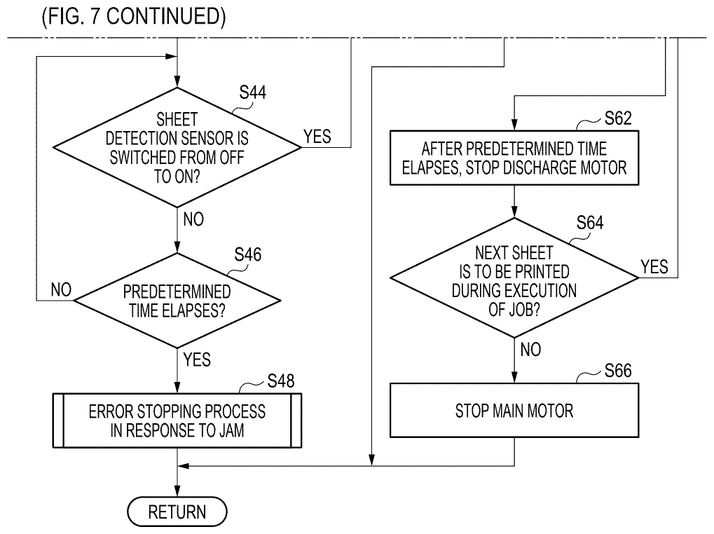

The ROM 102 is configured to store various control programs for controlling the printer 1, various settings, and the like. A printing process described later with reference to FIG. 6 is included in the control programs.

The RAM 103 is used as a work area where various control programs are read, and a storage area for temporarily storing image data included in the job. The CPU 101 is configured to control the units of the printer 1 while storing a process result in the RAM 103 or the NVRAM 104 in accordance with the control program read from the ROM 102 and signals output from various sensors.

The CPU 101 drives the cutting motor 106 to move the slide holder 16, so that the moving blade 15 is moved in a width direction of the sheet S to cut the sheet S.

The main motor 108 is configured to transmit the driving force to the pickup roller 33, the registration roller 35, the roller 36, the re-conveying rollers 38 and 39, the pressure roller 62, and the drum cartridge 5. In a case where the CPU 101 drives the main motor 108 to perform the forward rotation, the driving force is transmitted to the roller 36, the pressure roller 62, the photosensitive drum 51, the developing roller 55, the pickup roller 33, and the registration roller 35. The roller 36, the pressure roller 62, the photosensitive drum 51, the developing roller 55, the pickup roller 33, and the registration roller 35 rotate in a direction where the sheet S is conveyed in the conveying direction.

Specifically, the roller 36 and the pressure roller 62 is configured to rotate in the counterclockwise direction. The photosensitive drum 51 is configured to rotate in the clockwise direction. The developing roller 55 is configured to rotate in the counterclockwise direction. The pickup roller 33 is configured to rotate in the counterclockwise direction. The registration roller 35 is configured to rotate in the counterclockwise direction.

On the other hand, even when the CPU 101 drives the main motor 108 to perform the reverse rotation, the driving force is not transmitted to the roller 36, the pressure roller 62, the drum cartridge 5, the pickup roller 33, and the registration roller 35.

Furthermore, the CPU 101 is configured to drive the main motor 108 to perform the forward rotation, so that the driving force is transmitted to the re-conveying roller 38 and the re-conveying roller 39, and the rotation is performed in the clockwise direction. On the other hand, the CPU 101 drives the main motor 108 to perform the reverse rotation, so that the driving force is transmitted to the re-conveying roller 38 and the re-conveying roller 39, and the re-conveying roller 38 and the re-conveying roller 39 are rotated in the clockwise direction.

The discharge motor 109 is, for example, a stepping motor, and is configured to transmit a driving force to the first discharge roller 85, the second discharge roller 86, and the third discharge roller 87. In a case where the CPU 101 drives the discharge motor 109 to perform the forward rotation, the first discharge roller 85, the second discharge roller 86, and the third discharge roller 87 are rotated in the counterclockwise direction. Accordingly, the sheet S is discharged to the discharge tray 22 through the first discharge path 201A or the second discharge path 201B. On the other hand, the CPU 101 is configured to drive the discharge motor 109 to perform the reverse rotation, so that the first discharge roller 85, the second discharge roller 86, and the third discharge roller 87 are rotated in the clockwise direction. Accordingly, the sheet S being conveyed through the second discharge path 201B is conveyed in a direction opposite to the conveying direction.

The CPU 101 is configured to control the electromagnetic clutch 107. The CPU 101 is configured to turn on the electromagnetic clutch 107, so that the driving force of the main motor 108 is transmitted to the pickup roller 33, whereas the CPU 101 turns off the electromagnetic clutch 107, so that the driving force of the main motor 108 is not transmitted to the pickup roller 33.

The CPU 101 is configured to control the flapper 88. For example, by turning on/off a flapper solenoid (not shown), the CPU 101 can switch the position of the flapper 88 between a first position (position 88A indicated by a dashed line in FIG. 1) and a second position (position 88B indicated by a solid line in FIG. 1). The flapper 88 at the first position 88A is configured to guide the sheet S conveyed by the roller 36 to the first discharge path 201A. The flapper 88 at the second position 88B is configured to guide the sheet S conveyed by the roller 36 to the second discharge path 201B. The flapper 88 at the second position 88B is configured to guide the sheet S on the second discharge path 201B to the re-conveying path 202.

The pre-registration sensor SE1 is a sensor that is disposed at an upstream side of the registration roller 35 in the conveying path 201, and is configured to detect that the sheet S passes. The pre-registration sensor SE1 includes an actuator that swings in response to contact of the sheet S, and a photo sensor configured to detect a position of the actuator. The pre-registration sensor SE1 is configured to output an ON signal in a state where the sheet S passes, and is configured to output an OFF signal in a state where the sheet S does not pass. A detection signal from the pre-registration sensor SE1 is output to the CPU 101.

The post-registration sensor SE2 is a sensor that is disposed at the upstream side of the fixing unit 6 in the conveying path 201, specifically, between the registration roller 35 and the transfer roller 53, and detects that the sheet S passes. The post-registration sensor SE2 has the same configuration as that of the pre-registration sensor SE1. A detection signal from the post-registration sensor SE2 is output to the CPU 101.

The discharge sensor SE3 is disposed between the fixing unit 6 and the roller 36 in the conveying path 201, and is configured to detect that the sheet S passes. The discharge sensor SE3 has the same configuration as that of the pre-registration sensor SE1. A detection signal from the discharge sensor SE3 is output to the CPU 101.

The sheet detection sensor SE4 is disposed between the cutter position B and the second discharge roller 86, is configured to detect that the sheet S passes, and is configured to detect the open and closed state of the cover 23 that is opened and closed freely to cover the first discharge path 201A between the first discharge roller 85 and the second discharge roller 86. The sheet detection sensor SE4 is configured to output an ON signal in a case where the cover 23 is in the open state and in a case where the cover 23 is in the closed state and the sheet S passes, and is configured to output an OFF signal when the cover 23 is in the closed state and the sheet S does not pass.

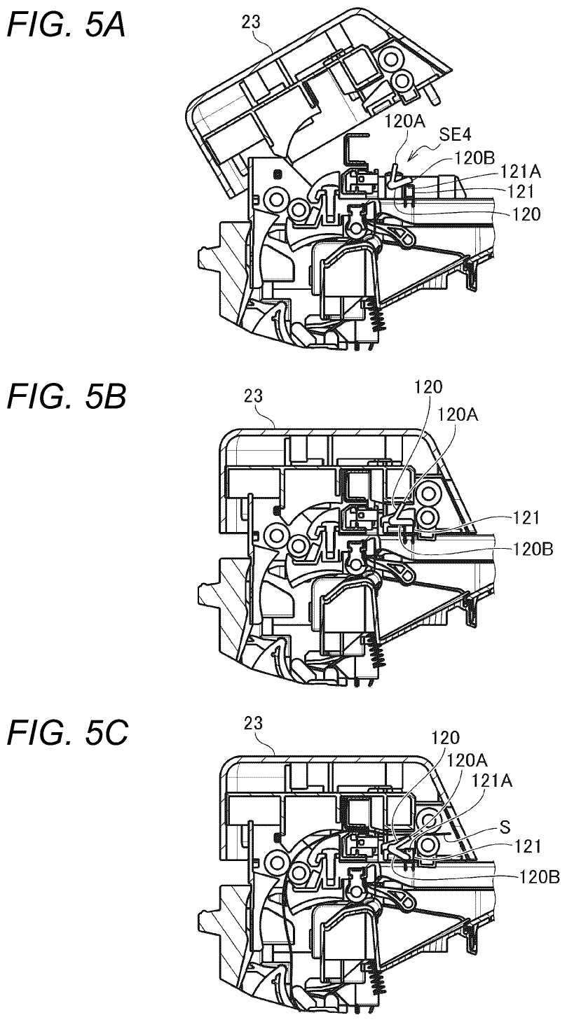

FIGS. 5A-5C shows an operation of the sheet detection sensor SE4, FIG. 5A shows a case where the cover 23 is in the open state, FIG. 5B shows a case where the cover 23 is in the closed state and the sheet S does not pass, and FIG. 5C shows a case where the cover 23 is in the closed state and the sheet S passes. As shown in FIGS. 5A-5C, the sheet detection sensor SE4 is an actuator type photo sensor, and includes an actuator 120 and a transmissive photo sensor 121. The transmissive photo sensor 121 includes a light emitter 121A and a light receiver (not shown), and outputs an OFF signal (an example of a second signal) when an optical path emitted from the light emitter 121A to the light receiver is blocked by the actuator 120, and outputs an ON signal (an example of a first signal) when the optical path is not blocked.

The actuator 120 includes a first arm portion 120A and a second arm portion 120B. The first arm portion 120A and the second arm portion 120B are formed in a V shape in a side view, that is, when viewed in a left-right direction, and are pivotable in the clockwise direction and the counterclockwise direction about a pivot shaft (not shown) in the left-right direction. When the cover 23 is in the open state as shown in FIG. 5A, the first arm portion 120A of the actuator 120 is separated from the cover 23, and thus, the actuator 120 pivots as much as possible in the counterclockwise direction by a biasing force of, for example, a spring. At this time, the optical path of the transmissive photo sensor 121 is not blocked by the actuator 120, and thus, the sheet detection sensor SE4 outputs the ON signal. When the cover 23 is in the closed state and the sheet S does not pass as shown in FIG. 5B, the cover 23 and an upper end of the first arm portion 120A of the actuator 120 are in contact with each other, and thus, the actuator 120 pivots in the clockwise direction as compared with the case where the cover 23 is in the open state. At this time, the optical path of the transmissive photo sensor 121 is blocked by the second arm portion 120B of the actuator 120, and thus, the sheet detection sensor SE4 outputs the OFF signal. When the cover 23 is in the closed state and the sheet S passes as shown in FIG. 5C, the first arm portion 120A of the actuator 120 and the sheet S come into contact with each other, and the actuator 120 further pivots in the clockwise direction. At this time, the optical path of the transmissive photo sensor 121 is not blocked by the second arm portion 120B of the actuator 120, and thus, the sheet detection sensor SE4 outputs the ON signal. The sheet detection sensor may be, for example, an optical sensor that does not have an actuator, emits light toward the conveying path, and receives the reflected light, or an optical sensor that determines whether the sheet is present in that position by emitting a different signal as a light reception amount changes depending on whether a sheet is present on the conveying path.

Returning to FIG. 3, the operation panel PA is disposed on an upper surface of the device main body 2. The operation panel PA includes, for example, a touch panel in which a touch pad and a display are integrally formed, and a key button portion. The operation panel PA is configured to accept a user operation and outputs the accepted information to the CPU 101. The user can set whether to cut the sheet S by, for example, operating the operation panel PA.

The communication I/F 130 is connected to a network such as a LAN, and can be connected to an external device such as a PC in which a driver for the printer 1 is incorporated. The CPU 101 is configured to receive a printing job via the communication I/F 130. The printing job includes the image data for image formation, the size and type of the sheet S used for image formation, various kinds of information necessary for forming an image on the sheet S, and information on whether to cut the sheet S.

Hereinafter, a control process executed by the printer 1 configured as described above will be described in detail with reference to FIGS. 6 to 13.

FIG. 6 shows a procedure of the printing process executed by the ASIC 105, particularly the CPU 101. This printing process is executed when the printer 1 can receive a printing job or a printing command, for example, when the printer 1 is powered on or when the printer 1 is in a standby state. Hereinafter, in descriptions of processes, a step is denoted as “S”.

In FIG. 6, first, the CPU 101 waits until the printing job is received via the communication I/F 130 or until the printing command is accepted via the operation panel PA (both of S10 and S12: NO), and if the printing job is received or the printing command is accepted (any one of S10 or S12: YES), the CPU 101 proceeds the process to S14.

In S14, the CPU 101 determines whether cutting of the sheet S to be printed is necessary. In the present embodiment, this determination is made based on information on whether to cut the sheet S, which is included in the printing job or the printing command. That is, if the user sets a mode in which the cutting of the sheet S is designated at the time of setting the printing job or a mode in which the cutting of the sheet S is designated at the time of setting the printing command via the operation panel PA, the information to cut the sheet S is included in the printing job or the printing command. In this determination, if it is necessary to cut the sheet S (S14: YES), the CPU 101 proceeds the process to S16. On the other hand, if it is unnecessary to cut the sheet S (S14: NO), the CPU 101 proceeds the process to S20.

In S16, the CPU 101 moves the flapper 88 to the first position 88A. As described above, the first position 88A is a position for guiding the sheet S conveyed by the roller 36 to the first discharge path 201A. Next, after executing a sheet printing and cutting process (S18), the CPU 101 ends the printing process.

On the other hand, in S20, the CPU 101 moves the flapper 88 to the second position 88B. As described above, the second position 88B is a position for guiding the sheet S conveyed by the roller 36 to the second discharge path 201B. Next, the CPU 101 performs normal printing (S22), and then ends the printing process. In the present embodiment, the normal printing means that after an image is printed on the sheet S based on the printing job or the printing command, the sheet S is discharged to the discharge tray 22 without being cut.

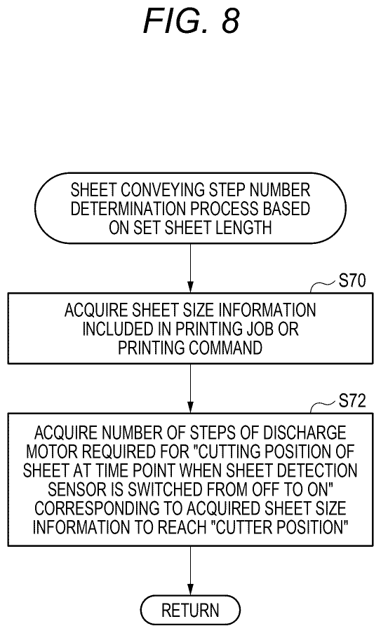

FIG. 7 shows a detailed procedure of the sheet printing and cutting process in S18. In FIG. 7, first, the CPU 101 executes a sheet conveying step number determination process based on set sheet length (S30). FIG. 8 shows a detailed procedure of the sheet conveying step number determination process based on set sheet length.

In FIG. 8, the CPU 101 acquires sheet size information included in the printing job or the printing command (S70). Specifically, the sheet size information is information such as “A4 size” or “letter size”. Then, the CPU 101 acquires the number of steps of the discharge motor required for the “cutting position of the sheet at a time point when the sheet detection sensor is switched from OFF to ON” corresponding to the acquired sheet size information to reach the “cutter position” (S72), and then ends the sheet conveying step number determination process based on set sheet length. More specifically, the number of steps of the discharge motor required for the corresponding “sheet cutting position at a time point when the sheet detection sensor is turned from OFF to ON” to reach the “cutter position” is stored in the ROM 102 or the NVRAM 104 for each sheet size in advance, and for example, if the sheet size information is A4, the CPU 101 acquires the stored number of steps corresponding to A4 from the ROM 102 or the NVRAM 104.

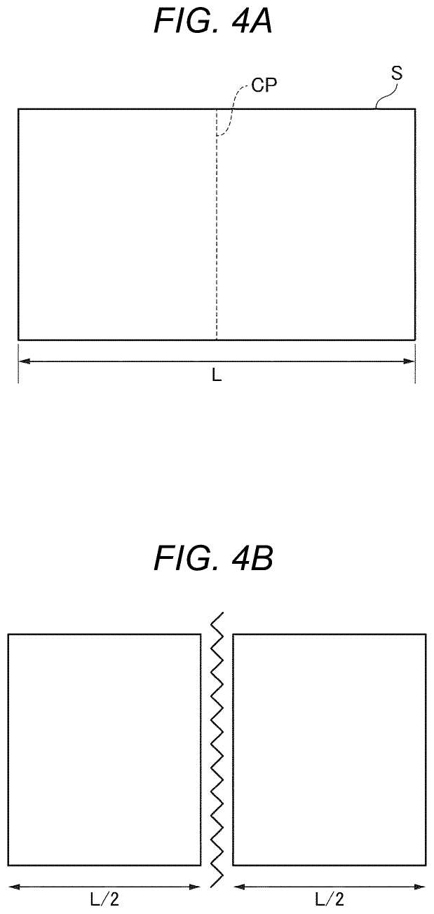

FIG. 4A, a cutting position CP of the sheet S is a center position of a sheet length L in the conveying direction. Therefore, in the process of S72, the CPU 101 acquires the number of steps of the discharge motor 109 required for the cutting position CP of the sheet S at the time point when the sheet detection sensor SE4 is switched from OFF to ON, that is, when the leading end of the sheet S is detected, that is, the center position to reach the cutter position B. The number of steps is a fixed value corresponding to the sheet size of the sheet S, and the number of steps corresponding to the sheet size information may be stored in advance in the NVRAM 104 by a factory setting or the like. In this case, in S72, the CPU 101 reads and acquires, from the NVRAM 104, the number of steps corresponding to the sheet size information acquired in S70.

Returning to FIG. 7, the CPU 101 drives the main motor 108 to perform the forward rotation (S32). At this time, the CPU 101 also turns on the heater 63.

Next, the CPU 101 executes a pickup command (S34). Accordingly, the CPU 101 turns on the electromagnetic clutch 107. When the electromagnetic clutch 107 is turned on, as described above, the driving force of the main motor 108 is transmitted to the pickup roller 33, and thus, the sheet S in the supply tray 31 is picked up and conveyed toward the conveying path 201.

Next, the CPU 101 waits until the post-registration sensor SE2 is switched from OFF to ON (S36: NO). As described above, the post-registration sensor SE2 is disposed between the registration roller 35 and the transfer roller 53 in the conveying path 201, outputs the ON signal in the state where the sheet S passes, and outputs the OFF signal when the sheet S does not pass. Therefore, in S36, the CPU 101 waits until the post-registration sensor SE2 detects the leading end of the sheet S. When the post-registration sensor SE2 detects the leading end of the sheet S (S36: YES), the CPU 101 starts to form an image on the sheet S (S38). The image formation may be started by a trigger except the case where the post-registration sensor SE2 detects the leading end of the sheet S. The image formation may be performed in such a manner that the toner image formed by the photosensitive drum 51 is correctly transferred to an image forming position of the sheet S.

Next, the CPU 101 waits until the discharge sensor SE3 is switched from OFF to ON (S40: NO). As described above, the discharge sensor SE3 is disposed between the fixing unit 6 and the roller 36 in the conveying path 201, outputs the ON signal in the state where the sheet S passes, and outputs the OFF signal in the state where the sheet S does not pass. Therefore, in S40, the CPU 101 waits until the discharge sensor SE3 detects the leading end of the sheet S. When the discharge sensor SE3 detects the leading end of the sheet S (S40: YES), the CPU 101 drives the discharge motor 109 to perform the forward rotation (S42). Accordingly, the first discharge roller to the third discharge roller 85 to 87 start to rotate.

Next, the CPU 101 determines whether the sheet detection sensor SE4 is switched from OFF to ON (S44). As described above, the sheet detection sensor SE4 is disposed between the cutter position B and the second discharge roller 86 in the conveying path 201, outputs the ON signal in the state where the sheet S passes, and outputs the OFF signal in the state where the sheet S does not pass. The sheet detection sensor SE4 outputs the ON signal even when the cover 23 is in the open state as described above, but this case is not taken into consideration here. Therefore, in S44, the CPU 101 determines whether the sheet detection sensor SE4 detects the leading end of the sheet S. When the sheet detection sensor SE4 does not detect the leading end of the sheet S (S44: NO), the CPU 101 determines whether a predetermined time elapses (S46), and if the predetermined time does not elapse (S46: NO), the CPU 101 returns the process to S44. On the other hand, when the predetermined time elapses (S46: YES), the CPU 101 executes an error stopping process in response to JAM (jam) (S48), and then ends the sheet printing and cutting process. Here, the “predetermined time” is a time that has a margin of a predetermined time added to the normal time required for the sheet detection sensor SE4 to detect the leading end of the sheet S after the discharge motor 109 is driven to perform the forward rotation. That is, if the sheet detection sensor SE4 does not detect the leading end of the sheet S even after the time elapses, the sheet S can be determined to be in a JAM state on the conveying path 201.

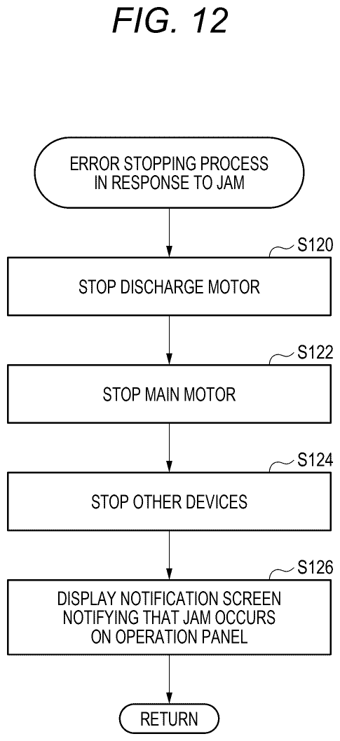

FIG. 12 illustrates a detailed procedure of the error stopping process in response to JAM. In FIG. 12, the CPU 101 stops the discharge motor 109 (S120), stops the main motor 108 (S122), and also stops other devices (S124). The other devices may include, for example, the image forming unit 4 and the fixing unit 6. Then, the CPU 101 displays, on the operation panel PA, a notification screen (not shown) notifying that the JAM occurs (S126), and then ends the error stopping process in response to JAM. In addition to the occurrence of the JAM, information indicating a position where the JAM occurs is also preferably displayed on the notification screen.

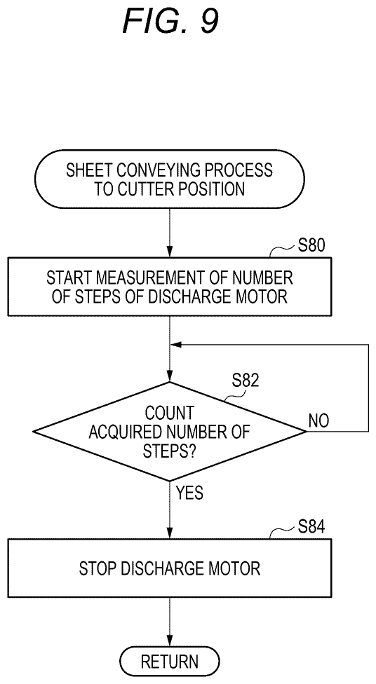

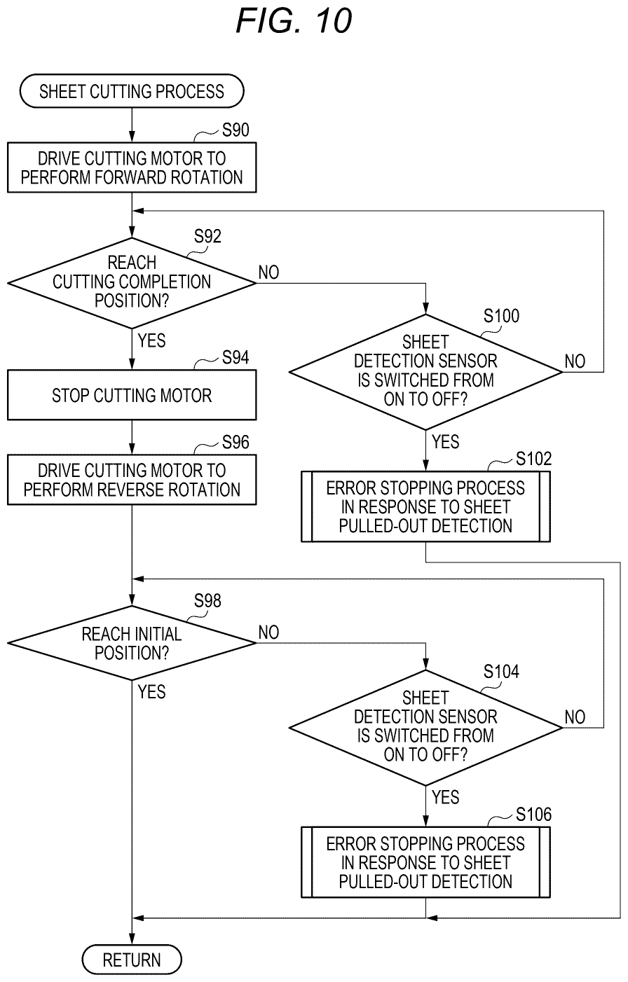

Returning to FIG. 7, it is determined in S44 that the sheet detection sensor SE4 detects the leading end of the sheet S (S44: YES), the CPU 101 executes the sheet conveying process to cutter position (S50). FIG. 9 shows a detailed procedure of the sheet conveying process to cutter position.

In FIG. 9, the CPU 101 starts measurement of the number of steps of the discharge motor 109 (S80). Since the discharge motor 109 is a stepping motor as described above, the CPU 101 can easily measure the number of steps of the discharge motor 109 simply by counting pulses input to a motor driver (not shown) of the discharge motor 109. The number of steps may be measured, for example, by counting up a step number measurement area (not shown) secured in the RAM 103.

Next, the CPU 101 waits until the number of steps acquired in S72 (FIG. 8) is counted (S82: NO), and if the counting of the number of steps is completed (S82: YES), the CPU 101 stops the discharge motor 109 (S84). Accordingly, the sheet S stops in the state where the cutting position CP reaches the cutter position B. The CPU 101 may set the number of steps acquired in S72 as an initial value, count down for each pulse input to the motor driver of the discharge motor 109, and stop the discharge motor 109 when the remaining number of steps becomes zero.

Returning to FIG. 7, the CPU 101 executes a sheet cutting process (S52). FIG. 10 shows a detailed procedure of the sheet cutting process. In FIG. 10, the CPU 101 drives the cutting motor 106 to perform the forward rotation (S90). Accordingly, the moving blade 15 moves in a direction where the moving blade 15 comes into contact with the sheet S, and the sheet S is started to be cut. Next, the CPU 101 determines whether the moving blade 15 reaches the cutting completion position (S92). That is, it is determined whether the cutting of the sheet S is completed. For example, when a DC motor with an encoder is employed as the cutting motor 106, a signal indicating a rotation direction, a rotation position, and a rotation speed according to the rotation of the cutting motor 106 is output from the encoder, and thus, the CPU 101 can determine based on this signal whether the moving blade 15 reaches the cutting completion position. If it is determined in S92 that the moving blade 15 does not reach the cutting completion position (S92: NO), the CPU 101 determines whether the sheet detection sensor SE4 is switched from ON to OFF (S100). In this determination, if the sheet detection sensor SE4 remains ON (S100: NO), the CPU 101 returns the process to S92. On the other hand, if the sheet detection sensor SE4 is switched from ON to OFF (S100: YES), the CPU 101 determines that the sheet S being cut is pulled out from the first discharge path 201A, and executes an error stopping process in response to sheet pulled-out detection (S102), and then ends the sheet cutting process.

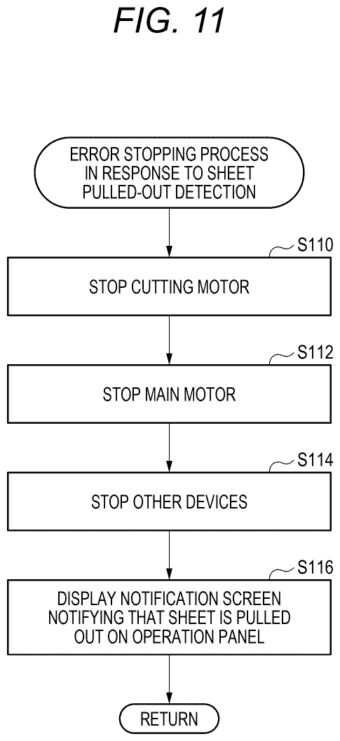

FIG. 11 shows a detailed procedure of the error stopping process in response to sheet pulled-out detection. In FIG. 11, the CPU 101 executes processes in S110 to S114 similar to S120 to S124, that is, the processes of stopping the discharge motor 109, the main motor 108, and other devices. Then, the CPU 101 displays, on the operation panel PA, a notification screen (not shown) notifying that the sheet is pulled out (S116), and then ends the error stopping process in response to sheet pulled-out detection.

Returning to FIG. 10, if it is determined in S92 that the moving blade 15 reaches the cutting completion position (S92: YES), the CPU 101 stops the cutting motor 106 (S94), and then drives the cutting motor 106 to perform the reverse rotation (S96). Accordingly, the moving blade 15 starts moving from the cutting completion position indicated by the dashed line toward the initial position indicated by the solid line in FIG. 2. Then, the CPU 101 determines whether the moving blade 15 reaches the initial position (S98), and if the moving blade 15 does not reach the initial position (S98: NO), the processes similar to S100 and S102 are performed in S104 and S106. That is, the CPU 101 determines whether the sheet S is pulled out from the first discharge path 201A while the moving blade 15 returns to the initial position, and if the sheet S is pulled out (S104: YES), the CPU 101 executes the error stopping process in response to sheet pulled-out detection.

On the other hand, if it is determined in S98 that the moving blade 15 reaches the initial position (S98: YES), the CPU 101 ends the sheet cutting process.

Returning to FIG. 7, the CPU 101 drives the discharge motor 109 to perform the forward rotation (S54). Accordingly, the sheet S cut at the cutting position CP starts to be conveyed toward the discharge tray 22. Next, the CPU 101 determines whether the sheet detection sensor SE4 is switched from ON to OFF (S56). That is, it is determined whether the discharge of the sheet S to the discharge tray 22 is completed. If the sheet detection sensor SE4 is not switched from ON to OFF even after a predetermined time elapses (S58: YES), that is, if the sheet S remains in the first discharge path 201A, the CPU 101 determines that the sheet S is in the JAM state, and after executing the same error stopping process in response to JAM as in S48 (S60), the CPU 101 ends the sheet printing and cutting process.

On the other hand, if it is determined in S56 that the sheet detection sensor SE4 is switched from ON to OFF (S56: YES), the discharge motor 109 is stopped after a predetermined time elapses (S62). Accordingly, the sheet S divided into two equal parts is discharged to the discharge tray 22. Therefore, the “predetermined time” is the time taken for the sheet on the upstream side in the conveying direction of the two equal parts of the sheet S to be discharged from the first discharge path 201A to the discharge tray 22.

Next, the CPU 101 determines whether a next sheet is to be printed in the job being executed (S64). If the next sheet is to be printed (S64: YES), the CPU 101 returns the process to S34 and continues the processes of S34 and the subsequent steps. On the other hand, if the next sheet is not printed (S64: NO), the CPU 101 stops the main motor 108 (S66), and then ends the sheet printing and cutting process.

Next, a cover open state detection process will be described. As described above, the sheet detection sensor SE4 is configured to output the ON signal in a case where the cover 23 is in the open state and in a case where the cover 23 is in the closed state and the sheet S passes, and is configured to output the OFF signal in a case where the cover 23 is in the closed state and the sheet S does not pass. The cover open state detection process is a process of detecting the open state of the cover 23, based on the output result of the sheet detection sensor SE4.

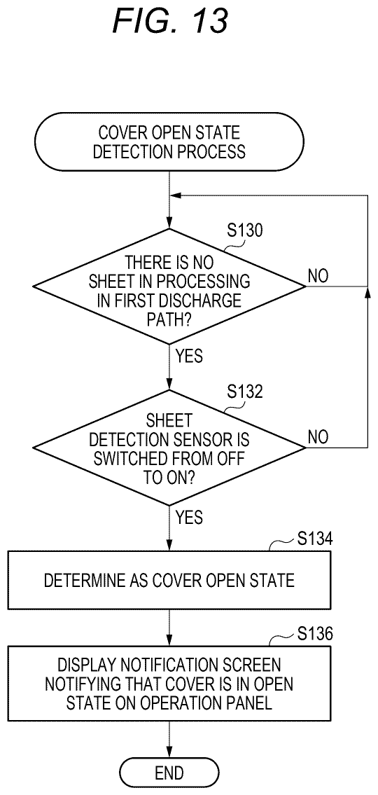

FIG. 13 shows a procedure of the cover open state detection process executed by the CPU 101. The cover open state detection process is performed in parallel with the printing process (FIG. 6), and is started, for example, when the printer 1 is powered on or when the printer 1 is in a standby state.

In FIG. 13, the CPU 101 determines whether the sheet detection sensor SE4 is switched from OFF to ON in a state where there is no sheet S in processing in the first discharge path 201A (S130, S132). In this determination, if the sheet detection sensor SE4 is switched from OFF to ON in the state where there is no sheet S in processing in the first discharge path 201A (S130, S132: YES), the CPU 101 determines that the cover 23 is in the open state (S134), and displays, on the operation panel PA, a notification screen (not shown) notifying that the cover 23 is in the open state (S136), and then ends the cover open state detection process.

The sheet detection sensor SE4 outputs the ON signal when the cover 23 is in the open state and when the cover 23 is in the closed state and the sheet S passes, and thus, in order to determine that the cover 23 is in the open state, it is necessary to exclude a case where the cover 23 is in the closed state and the sheet S passes. That is, in S130, if there is no sheet S in the processing in the first discharge path 201A, the sheet detection sensor SE4 is not turned on by the passage of the sheet S, and thus, it is determined that the sheet detection sensor SE4 is not turned on by the passage of the sheet S. In step S132, it is determined that the sheet detection sensor SE4 is not turned on by the passage of the sheet S, but the sheet detection sensor SE4 is turned on by the cover 23 being in the open state.

As described above, the printer 1 of the present embodiment includes the device main body 2 including the conveying path 201 of the sheet S; the fixing unit 6 including the heating roller 61 and the pressure roller 62 in which the nip N is formed between the heating roller 61 and the pressure roller 62, and configured to fix an image formed on the sheet S onto the sheet S; the first discharge roller 85 located at the downstream side of the fixing unit 6 in the conveying direction of the sheet S along the conveying path 201, and configured to convey the sheet S; the second discharge roller 86 located at the downstream side of the first discharge roller 85 in the conveying direction, and configured to discharge the sheet S conveyed by the first discharge roller 85 to the outside of the device main body 2; the cutter 10 located at the cutter position B, which is a position between the first discharge roller 85 and the second discharge roller 86 in the conveying direction, and configured to cut the sheet S in the cutting direction intersecting the conveying direction; and the sheet detection sensor SE4 configured to detect whether the sheet S is present at the first detection position between the first discharge roller 85 and the second discharge roller 86 in the conveying direction.

Accordingly, in the printer 1 of the present embodiment, the cutter 10 is disposed between the first discharge roller 85 and the second discharge roller 86 in the conveying direction, and whether the sheet S is present at the detection position between the same first discharge roller 85 and the same second discharge roller 86 is detected, and thus, the sheet S around the cutter 10 can be accurately detected.

Incidentally, in the present embodiment, the heating roller 61 is an example of the “heating rotor”. The pressure roller 62 is an example of the “pressure rotor”. The sheet detection sensor SE4 is an example of a “first sensor”.

The printer 1 further includes the CPU 101. The CPU 101 is configured to execute the conveying process of driving, based on the output of the sheet detection sensor SE4, the first discharge roller 85 and the second discharge roller 86 with the number of steps required to convey the sheet S since the leading end of the sheet S reaches the first detection position until the cutting position of the sheet S reaches the cutter position B, and then stopping conveying the sheet S, and the cutting process of cutting the sheet S in the cutting direction by using the cutter 10 after the conveying process. Incidentally, the CPU 101 is an example of the “controller”. The number of steps is an example of a “driving amount”.

Accordingly, the sheet S is conveyed until the cutting position CP of the sheet S reaches the cutter position B based on the output of the sheet detection sensor SE4 located in the vicinity of the cutter position B, and the sheet S is cut at the conveying position, and thus, the sheet S can be cut accurately at the cutting position CP of the sheet S.

The CPU 101 receives the printing job including the sheet size of the sheet S, and executes the driving amount acquiring process of acquiring the number of steps based on the sheet size included in the received printing job, and in the conveying process, the CPU 101 drives the first discharge roller 85 and the second discharge roller 86 with the number of steps acquired by the step number acquiring process, and then stops conveying the sheet S.

Accordingly, the number of steps of the discharge motor 109 can be acquired based on the sheet size, which is simple information included in the received printing job, and thus, the process of acquiring the number of steps can be simplified.

The printer 1 further includes the discharge motor that drives the first discharge roller 85 and the second discharge roller 86. During the conveying process, if the sheet detection sensor SE4 does not detect the sheet S even after the predetermined time since starting driving of the discharge motor 109 elapses, the CPU 101 stops the driving of the discharge motor 109.

Accordingly, occurrence of a jam in the sheet S during the conveying process can be accurately determined, and an error process in response to the occurrence of the jam can be accurately performed.

The printer 1 further includes the main motor 108 that rotationally drives any one of the heating roller 61 or the pressure roller 62. During the conveying process, if the sheet detection sensor SE4 does not detect the sheet S even after the predetermined time since starting driving of the discharge motor 109 elapses, the CPU 101 also stops the driving of the main motor 108.

Accordingly, the error process in response to the occurrence of the jam can be more accurately performed.

The device main body 2 further includes a display panel, and during the conveying process, if the sheet detection sensor SE4 does not detect the sheet S even after the predetermined time since starting driving of the discharge motor 109 elapses, the CPU 101 causes the operation panel PA to display the notification screen notifying that a jam occurs.

Accordingly, a user can be accurately notified of the occurrence of the jam in the sheet S during the conveying process.

The printer 1 further includes the discharge motor 109 that drives the first discharge roller 85 and the second discharge roller 86. After the cutting process, the CPU 101 executes the discharge process of driving the first discharge roller 85 and the second discharge roller 86 to discharge the cut sheet S to the outside of the device main body 2, and during the discharge process, if the sheet detection sensor SE4 detects the sheet S even after the predetermined time since starting driving of the discharge motor 109 elapses, the CPU 101 stops the driving of the discharge motor 109.

Accordingly, the occurrence of the jam in the sheet S during the discharge process after cutting can be accurately determined, and the error process in response to the occurrence of the jam can be accurately performed.

The device main body 2 further includes the operation panel PA, and during the discharge process, if the sheet detection sensor SE4 does not detect the sheet S even after the predetermined time since starting driving of the discharge motor 109 elapses, the CPU 101 causes the operation panel PA to display the notification screen notifying that a jam occurs. Incidentally, the operation panel PA is an example of the “display panel”.

Accordingly, a user can be accurately notified of the occurrence of the jam in the sheet S during the discharge process after the cutting.

The cutter 10 includes the moving blade 15 for cutting the sheet S and the cutting motor 106 for moving the moving blade 15 in the cutting direction, and during the cutting process, when the cutting motor 106 is performing driving and the discharge motor 109 is not performing driving, if the sheet detection sensor SE4 changes from the state where the sheet S is detected to the state where the sheet S is not detected, the CPU 101 stops the driving of the cutting motor 106. Incidentally, the moving blade 15 is an example of a “blade”.

Accordingly, it is possible to accurately determine that the sheet S is pulled out during the cutting process, and to accurately perform the error process in response thereto.

The sheet detection sensor SE4 detects whether the sheet S is present at the detection position between the cutter 10 and the second discharge roller 86.

Accordingly, the sheet S around the cutter 10 can be accurately detected.

The printer 1 further includes the cover 23 that is opened and closed freely to cover the conveying path 201 between the first discharge roller 85 and the second discharge roller 86. The sheet detection sensor SE4 outputs the ON signal when the cover 23 is in the open state and when the cover 23 is in the closed state and the sheet S is detected, and outputs the OFF signal when the cover 23 is in the closed state and the sheet S is not detected, and if the ON signal is output from the sheet detection sensor SE4 when the sheet S is not conveyed by the first discharge roller 85 and the second discharge roller 86, the CPU 101 determines that the cover 23 is in the open state. The ON signal is an example of the “first signal”. The OFF signal is an example of the “second signal”.

Accordingly, both the detection of the sheet S and the detection of the open state of the cover 23 can be performed by the one sheet detection sensor SE4, and a manufacturing cost of the entire printer 1 can be reduced.

The printer 1 further includes the third discharge roller 87 located on the second discharge path 201B branched from the conveying path 201 between the fixing unit 6 and the first discharge roller 85, located at a position shorter than the length of the conveying path 201 from the fixing unit 6 to the second discharge roller 86, and configured to discharge the sheet S to the outside of the device main body 2. The CPU 101 receives the printing job including the cutting information indicating whether the sheet S is cut, and causes the third discharge roller 87 to convey the sheet S and discharges the sheet S without being cut from the device main body 2 to the outside if the cutting information included in the received printing job indicates that the sheet S is not cut. Incidentally, the printing job is an example of “printing data”. The second discharge path 201B is an example of a “discharge path”.

Accordingly, if the sheet S is not cut, the sheet S is discharged to the outside of the device main body 2 through a short path of the conveying path 201, and thus, the uncut sheet S can be quickly discharged to the outside of the device main body 2.

The printer 1 further includes the flapper 88 configured to be switched between the first position 88A for guiding the sheet S toward the first discharge roller 85 and the second position 88B for guiding the sheet S toward the third discharge roller 87. If the cutting information indicates that the sheet S is cut, the CPU 101 switches the flapper 88 to the first position 88A after the leading end of the sheet S leaves the fixing unit 6 and before the leading end of the sheet S reaches the flapper 88, and if the cutting information indicates that the sheet S is not cut, the CPU 101 switches the flapper 88 to the second position 88B after the leading end of the sheet S leaves the fixing unit 6 and before the leading end of the sheet S reaches the flapper 88.

Accordingly, the sheet S is automatically guided toward any one of the first discharge roller 85 or the third discharge roller 87 based on the cutting information included in the printing job, which is convenient.

A length of the conveying path 201 from the fixing unit 6 to the cutter 10 is longer than half a sheet length of a cuttable sheet in the conveying direction.

Accordingly, when the sheet S is cut at the cutter position B, a state where the sheet S is sandwiched by the nip N of the fixing unit 6 is eliminated, and thus, heat can be prevented from being applied to the sheet S from the heating roller 61 in a state where the rotation of the pressure roller 62 is stopped. The length in the present embodiment is a length in the conveying direction from a downstream end of the nip N of the fixing unit 6 in the conveying direction to the fixing blade 13 of the cutter 10, and for example, the length may be a length in the conveying direction from a downstream end of an outer periphery of the pressure roller 62 or the heating roller 61 of the fixing unit 6 in the conveying direction to the fixing blade 13 of the cutter 10.

The printer 1 further includes the discharge motor 109 configured to drive the first discharge roller 85; the roller 36 located between the first discharge roller 85 and the fixing unit 6; and the main motor 108 configured to drive the roller 36 and the fixing unit 6, in which a length of the conveying path 201 from the roller 36 to the cutter 10 is longer than half the sheet length of the cuttable sheet S in the conveying direction, and the CPU 101 keeps the main motor 108 driven during the cutting process.

Accordingly, when the sheet S is cut at the cutter position B, the sheet S can be stopped at the cutter position B by stopping only the discharge motor 109 without stopping the driving of the roller 36 and the fixing unit 6 by the main motor 108.

### Second Embodiment

Next, a second embodiment of the present application will be described. The present embodiment is configured by partially changing the sheet printing and cutting process (see FIG. 7) described in the first embodiment, and thus, the changed parts will be mainly described and descriptions of other parts will be omitted as appropriate. Hardware according to the present embodiment uses the hardware shown in FIGS. 1 to 3 as it is.

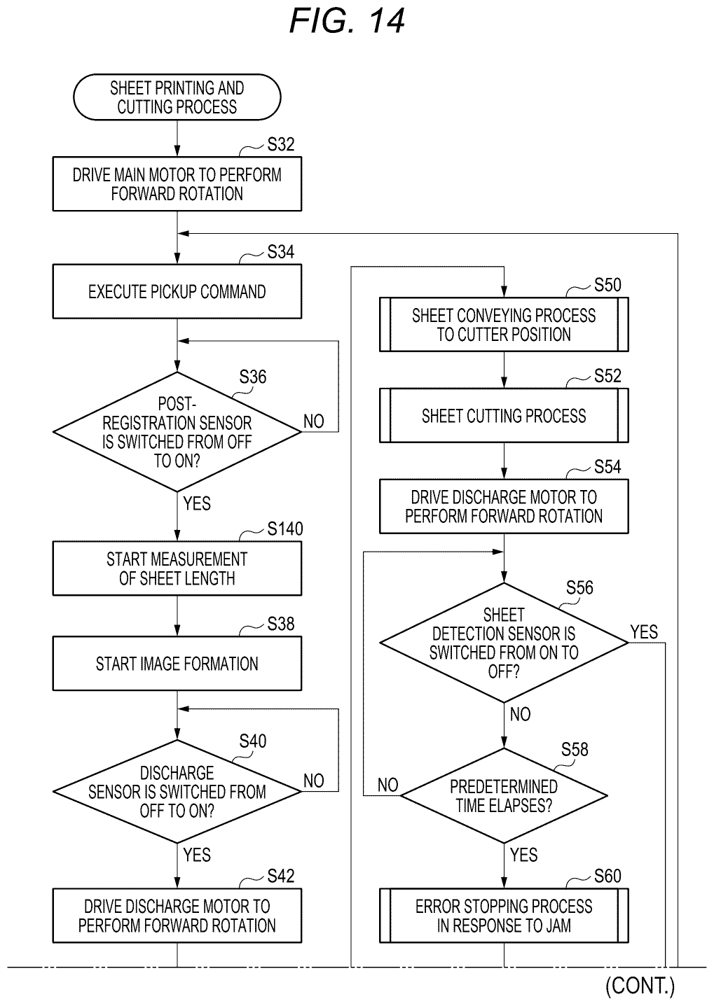

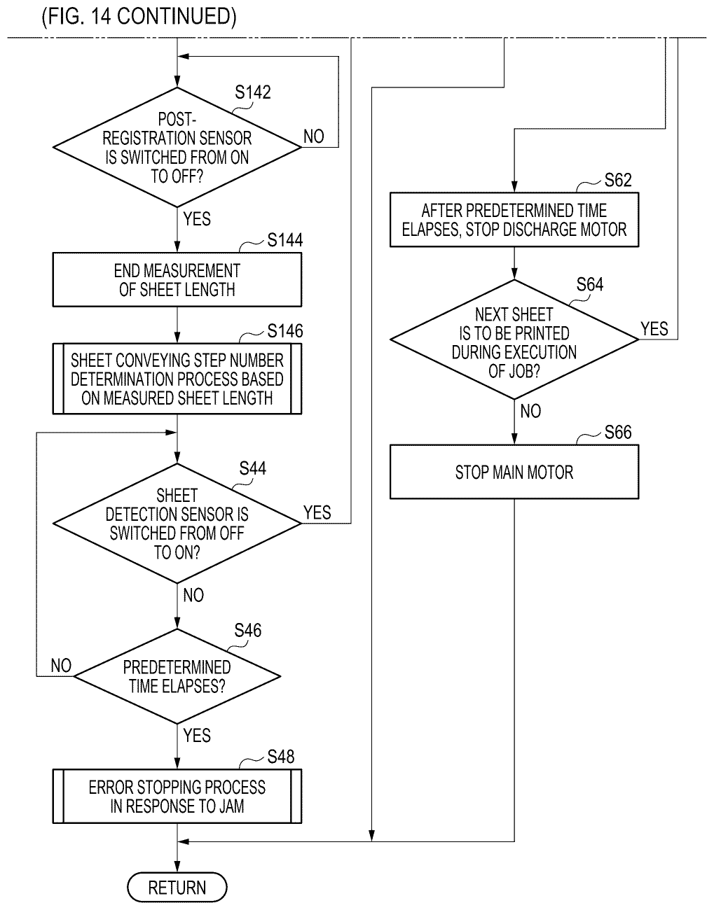

FIG. 14 shows a procedure of a sheet printing and cutting process executed by the ASIC 105, in particular, the CPU 101 of the printer 1 of the present embodiment. In the sheet printing and cutting process of FIG. 7, the number of steps of the discharge motor 109 required for the cutting position CP of the sheet S to reach the cutter position B is determined by the sheet conveying step number determination process based on set sheet length (S30), whereas the sheet printing and cutting process in FIG. 14 is different in that the number of steps of the discharge motor 109 required for the cutting position CP of the sheet S to reach the cutter position B is determined by a sheet conveying step number determination process based on measured sheet length (S146). Therefore, in FIG. 14, the same process as that in FIG. 7 is denoted by the same reference numeral, and a description thereof is appropriately omitted.

When the post-registration sensor SE2 detects the leading end of the sheet S (S36: YES), the CPU 101 starts to measure the sheet length of the sheet S (S140). Since the sheet length is measured by measuring a time, the CPU 101 may, for example, count up a timer area (not shown) secured in the RAM 103 at predetermined time intervals (for example, every 0.01 seconds). In this case, in S140, the CPU 101 starts to count up the timer area.

Next, after executing the processes of S38 to S42, the CPU 101 waits until the post-registration sensor SE2 detects the trailing end of the sheet S (S142: NO). If the post-registration sensor SE2 detects the trailing end of the sheet S (S142: YES), the CPU 101 ends the measurement of the sheet length of the sheet S (S144). That is, the CPU 101 ends counting up the timer area.

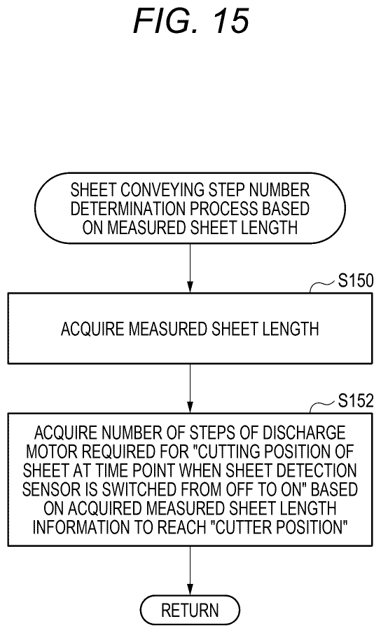

Next, the CPU 101 executes the sheet conveying step number determination process based on measured sheet length (S146). FIG. 15 shows a detailed procedure of the sheet conveying step number determination process based on measured sheet length. In FIG. 15, the CPU 101 acquires measured sheet length information (S150). In the present embodiment, the measured sheet length information is a count value of the timer area, and thus, the CPU 101 reads and acquires the count value from the timer area.

Next, the CPU 101 calculates the number of steps of the discharge motor required for the “cutting position of the sheet at a time point when the sheet detection sensor is turned from OFF to ON” based on the acquired measured sheet length information to reach the “cutter position” (S152), and then ends the sheet conveying step number determination process based on measured sheet length.

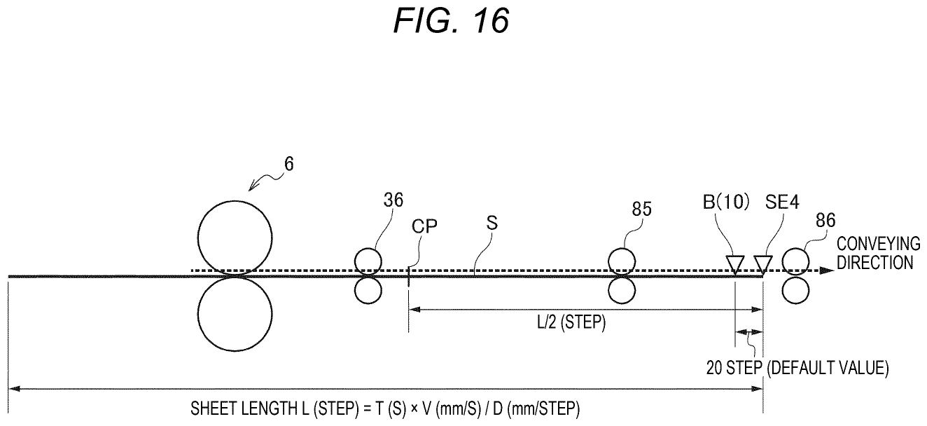

FIG. 16 is a diagram for illustrating the sheet cutting position determination process based on the measured sheet length in FIG. 15. As shown in FIG. 16, the CPU 101 calculates the sheet length L of the sheet S by the number of steps of the discharge motor 109 based on the following Formula (1).

$$L ( STEP ) = T ( s ) \times V ( mm / s ) D ( mm / STEP ) , \qquad ( 1 )$$

where T represents a time elapsing since the post-registration sensor SE2 detects the leading end of the sheet S until the trailing end of the sheet S is detected=count value of the timer area×time per count, V represents a conveying speed at which the main motor 108 conveys the sheet S, and D represents a conveying distance per step of the discharge motor 109.

If it is assumed that the cutting position CP of the sheet S is the center of the sheet length, the number of steps from the sheet detection sensor SE4 to the cutting position CP is L/2. Furthermore, the cutter position B is located at an upstream side of 20 STEPS from the detection position of the sheet detection sensor SE4, and the number of steps calculated in S152 is L/2-20 (STEPS).

Therefore, when the CPU 101 executes the sheet conveying process to cutter position (S50 in FIG. 14), the sheet S stops in the state where the cutting position CP reaches the cutter position B.

As described above, the printer 1 of the present embodiment further includes the post-registration sensor SE2 that detects whether the sheet S is present at the second detection position which is the upstream side of the sheet detection sensor SE4 in the conveying direction. The CPU 101 executes a sheet length acquiring process of detecting based on the output of the post-registration sensor SE2 that the trailing end of the sheet S reaches the second detection position after the leading end of the sheet S reaches the second detection position, and acquiring the sheet length of the sheet S in the conveying direction based on the detected leading end and trailing end of the sheet S, and a driving amount acquiring process of acquiring the number of steps based on the sheet length acquired by the sheet length acquiring process, and in the conveying process, the CPU 101 drives the first discharge roller 85 and the second discharge roller 86 with the number of steps acquired by the step number acquiring process, and then stops conveying the sheet S. Incidentally, the post-registration sensor SE2 is an example of a “second sensor”.

Accordingly, the number of steps can be acquired based on the measured sheet length of the sheet S, and even if the sheet S shrinks and the sheet length becomes shorter than an original sheet length, the sheet S can be accurately cut at an intended cutting position.

In the sheet length acquiring process, the CPU 101 acquires the sheet length of the sheet S in the conveying direction based on a conveying amount of the sheet S since the leading end of the sheet S is detected until the trailing end of the sheet S is detected based on the output of the post-registration sensor SE2.

Accordingly, the sheet length of the sheet S can be acquired based on the output of the post-registration sensor SE2 already installed in the printer 1, and a manufacturing cost of the entire printer 1 can be reduced.

### Third Embodiment

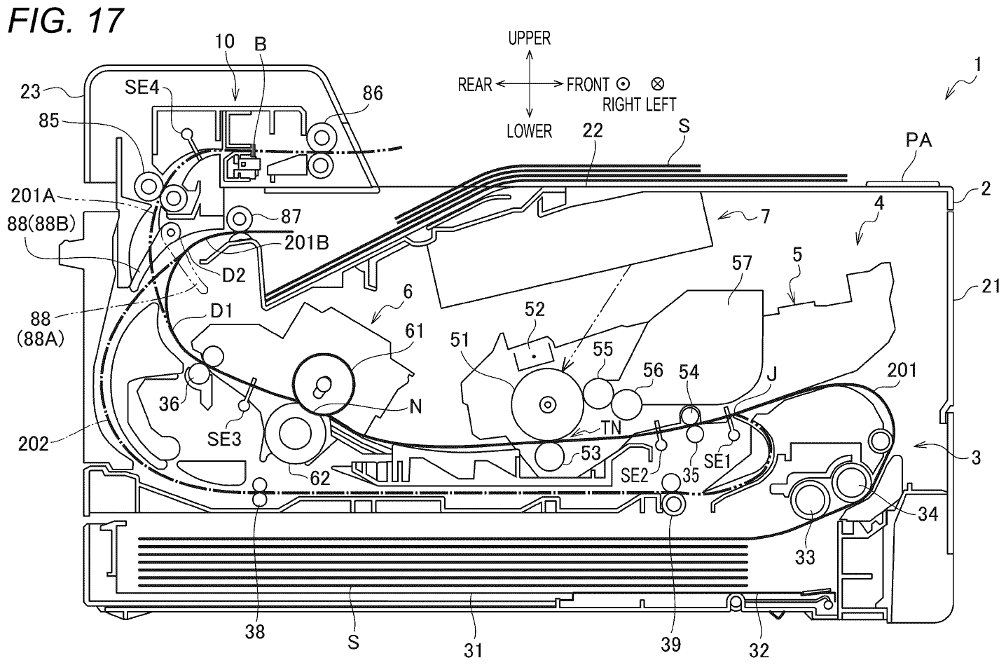

Next, a third embodiment of the present application will be described. A control process executed by the printer 1 of the present embodiment will be described in detail with reference to FIG. 6 and FIGS. 17 to 21. In the present embodiment, an installation position of the sheet detection sensor SE4 described in the first embodiment is changed. Hardware of the present embodiment uses almost all of the hardware described in FIGS. 1 to 3, but in order to clarify the installation position of the sheet detection sensor SE4 in the present embodiment, a cross-sectional view in FIG. 17 is used instead of FIG. 1. Here, in FIG. 17, the same members as those in FIG. 1 are denoted by the same reference numerals.

The sheet detection sensor SE4 in the present embodiment is a sensor that is disposed between the first discharge roller 85 and the cutter position B and configured to detect that the sheet S passes. The sheet detection sensor SE4 has the same configuration as that of the pre-registration sensor SE1. A detection signal from the sheet detection sensor SE4 is output to the CPU 101.

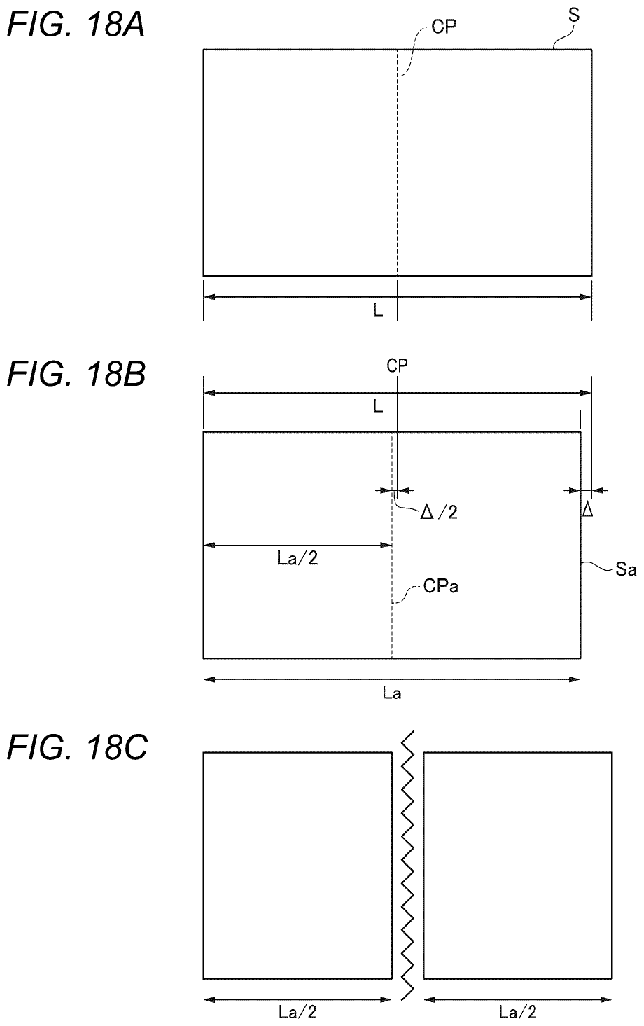

FIGS. 18A-18C is a diagram for illustrating a problem that occurs when cutting a sheet Sa obtained by the sheet S shrinking and a countermeasure for the problem. FIG. 18A shows the sheet S before shrinking, and a dashed line in FIG. 18A represents the cutting position CP for cutting the sheet S at the center in a longitudinal direction, that is, the conveying direction. On the other hand, FIG. 18B shows a state where the sheet S having the length L in the longitudinal direction shrinks by a length Δ to become the sheet Sa having a length La. When the sheet Sa is cut at the cutting position CP of the sheet S, in the two sheets after cutting, a length of the sheet on the downstream side in the conveying direction, that is, the sheet on the left side in FIGS. 18A-18C is longer than a length of the sheet on the right side, and thus, the sheet Sa cannot be accurately cut in half. Therefore, the cutting position CP is cut at a cutting position CPa that is shifted by a length Δ/2 on the downstream side in the conveying direction. If the cutting is performed at the cutting position CPa, the sheet Sa can be cut into two sheets each having a length La/2 as shown in FIG. 18C. Hereinafter, the control process for cutting the shrinking sheet Sa in half will be described.

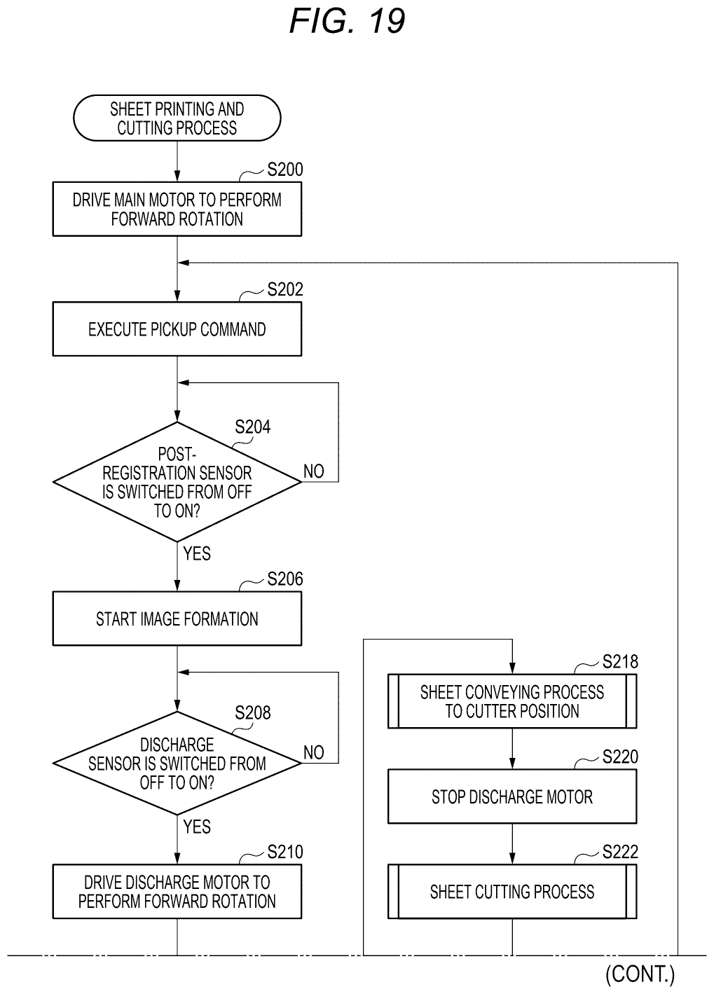

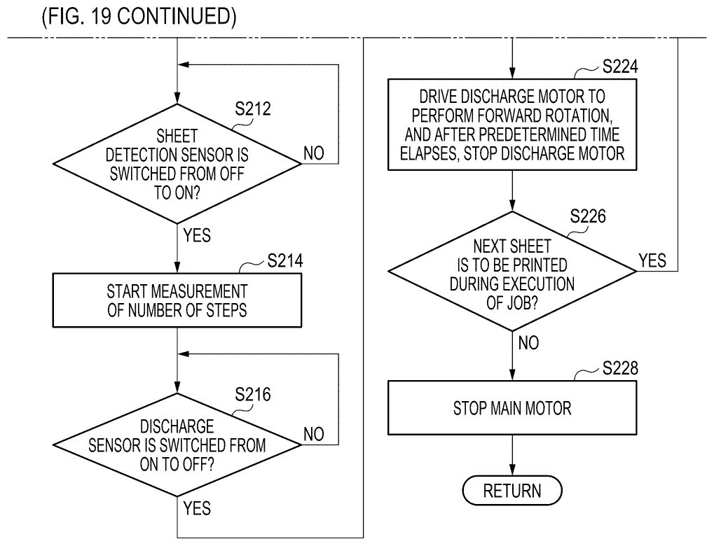

FIG. 19 shows a detailed procedure of the sheet printing and cutting process in S18 of FIG. 6 in the present embodiment. In FIG. 19, first, the CPU 101 drives the main motor 108 to perform the forward rotation (S200). At this time, the CPU 101 also turns on the heater 63.

Next, the CPU 101 executes a pickup command (S202). Accordingly, the CPU 101 turns on the electromagnetic clutch 107. When the electromagnetic clutch 107 is turned on, as described above, the driving force of the main motor 108 is transmitted to the pickup roller 33, and thus, the sheet S in the supply tray 31 is picked up and conveyed toward the conveying path 201.

Next, the CPU 101 waits until the post-registration sensor SE2 is switched from OFF to ON (S204: NO). As described above, the post-registration sensor SE2 is disposed between the registration roller 35 and the transfer roller 53 in the conveying path 201, outputs the ON signal in the state where the sheet S passes, and outputs the OFF signal when the sheet S does not pass. Therefore, in S204, the CPU 101 waits until the post-registration sensor SE2 detects the leading end of the sheet S. If the post-registration sensor SE2 detects the leading end of the sheet S (S204: YES), the CPU 101 starts to form an image on the sheet S by the image forming unit 4 (S206).

Next, the CPU 101 waits until the discharge sensor SE3 is switched from OFF to ON (S208: NO). As described above, the discharge sensor SE3 is disposed between the fixing unit 6 and the roller 36 in the conveying path 201, outputs the ON signal in the state where the sheet S passes, and outputs the OFF signal in the state where the sheet S does not pass. Therefore, in S208, the CPU 101 waits until the discharge sensor SE3 detects the leading end of the sheet S. If the discharge sensor SE3 detects the leading end of the sheet S (S208: YES), the CPU 101 drives the discharge motor 109 to perform the forward rotation (S210). Accordingly, the first discharge roller to the third discharge roller 85 to 87 start to rotate. The CPU 101 controls the discharge motor 109 and the main motor 108 such that a rotation speed of the discharge motor 109 is higher than a rotation speed of the main motor 108. This is because, when the sheet S is conveyed in a flexing state between the roller 36 and the first discharge roller 85 or the third discharge roller 87, the flexing is eliminated. That is, this is because, if a conveying speed of the first discharge roller 85 and the third discharge roller 87 is higher than a conveying speed of the roller 36, the sheet S is conveyed by the first discharge roller 85 or the third discharge roller 87, so that a conveying speed of a portion of the sheet S that passes through the roller 36 becomes faster, and thus, the flexing state is gradually eliminated.

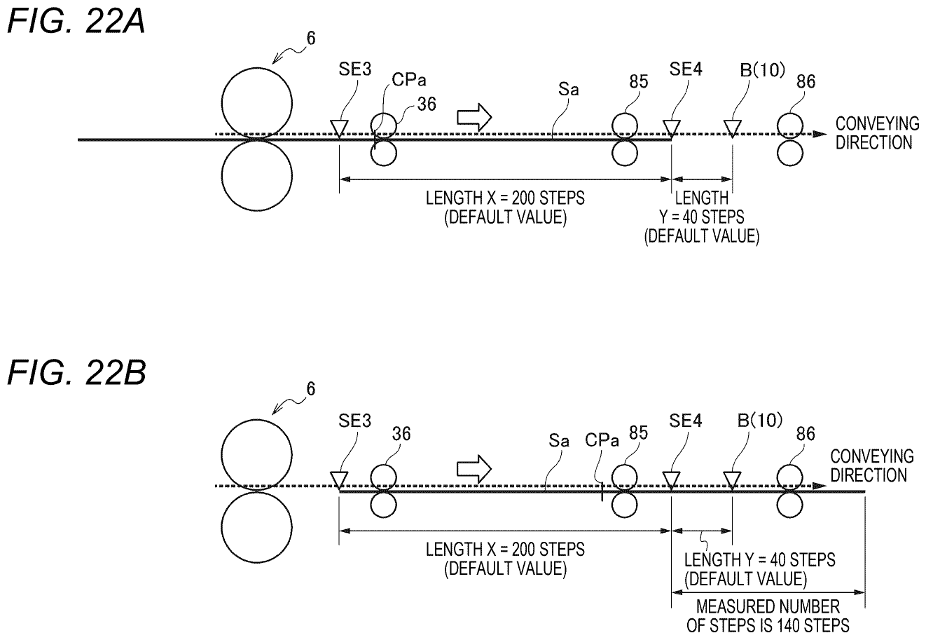

Next, the CPU 101 waits until the sheet detection sensor SE4 switches from OFF to ON (S212: NO). As described above, the sheet detection sensor SE4 is disposed between the first discharge roller 85 and the cutter position B in the conveying path 201, outputs the ON signal in the state where the sheet S passes, and outputs the OFF signal in the state where the sheet S does not pass. Therefore, in S212, the CPU 101 waits until the sheet detection sensor SE4 detects the leading end of the sheet S. If the sheet detection sensor SE4 detects the leading end of the sheet S (S212: YES), the CPU 101 starts to measure the number of STEPS of the discharge motor 109 (S214). Since the discharge motor 109 is a stepping motor as described above, the CPU 101 can measure, that is, count the number of STEPS when the discharge motor 109 is operated. The measurement result (number of counts) may be stored in, for example, a STEP number count area (not shown) secured in a predetermined area of the RAM 103. FIG. 22A shows a state where a leading end of the sheet Sa reaches the detection position of the sheet detection sensor SE4.

Next, the CPU 101 waits until the discharge sensor SE3 switches from ON to OFF (S216: NO). That is, in S216, the CPU 101 waits until the discharge sensor SE3 detects the trailing end of the sheet S. If the discharge sensor SE3 detects the trailing end of the sheet S (S216: YES), the CPU 101 executes the sheet conveying process to cutter position (S218). FIG. 22B shows a state where the trailing end of the sheet Sa reaches the detection position of the discharge sensor SE3.

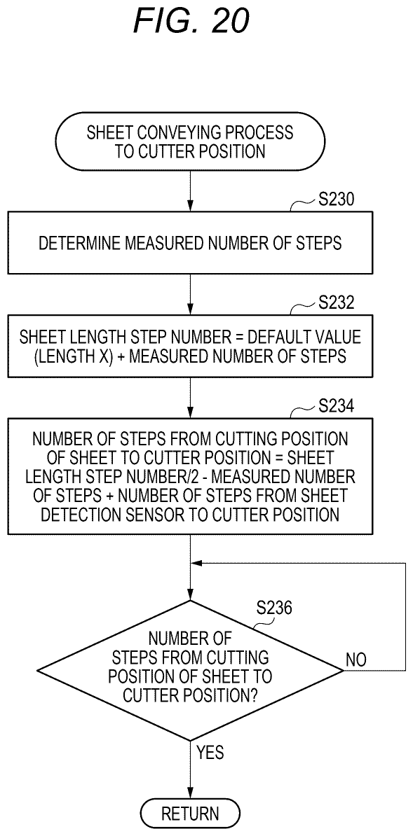

FIG. 20 shows a detailed procedure of the sheet conveying process to cutter position in S218. In FIG. 20, first, the CPU 101 determines the measured number of STEPS (S230). The measured number of STEPS (an example of a second rotation amount) is the number of STEPS since the sheet detection sensor SE4 detects the leading end of the sheet Sa until the discharge sensor SE3 detects the trailing end of the sheet Sa. The measured number of STEPS may be determined by reading the count value stored in the STEP number count area.

Next, the CPU 101 calculates a sheet length STEP number of the sheet S by adding a default value (length X: expression in number of STEPS) to the measured number of STEPS (S232). Then, the CPU 101 calculates the number of STEPS from the cutting position CP of the sheet S to the cutter position B in the conveying path 201 including the first discharge path 201A based on the following Formula (2) (S234).

$$Sheet length STEP \text{number/} 2 - measured number of STEPS + number of STEPS from sheet detection sensor SE 4 to cutter position B \qquad ( 2 )$$

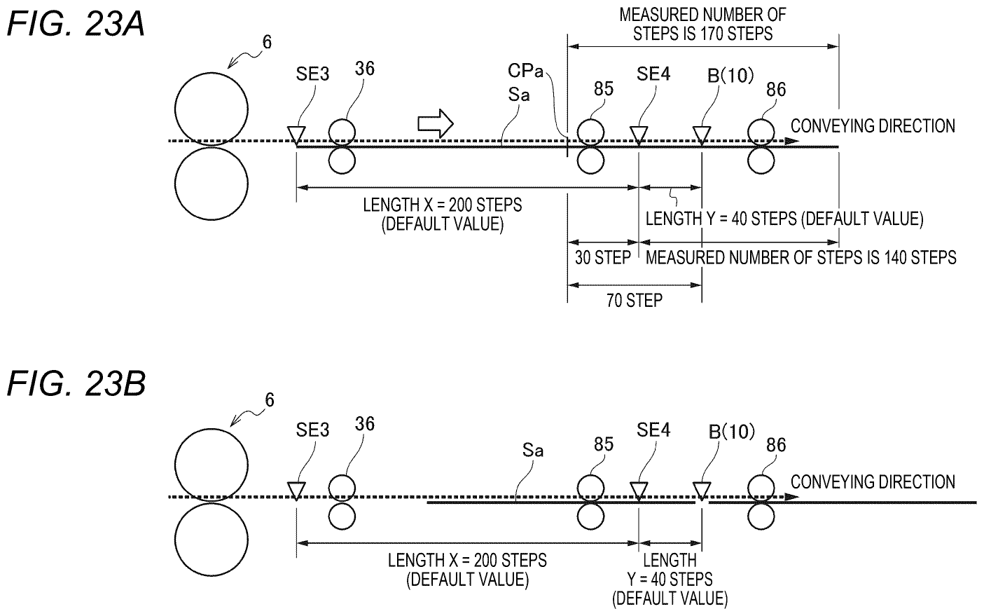

FIG. 23A is a diagram illustrating the processes of S232 and S234, and illustrates a state where the trailing end of the sheet Sa reaches the detection position of the discharge sensor SE3. At this time, the measured number of STEPS determined in S230 is 140 STEPS. The length X from the discharge sensor SE3 to the sheet detection sensor SE4 is 200 STEPS which is a fixed default value, and thus, the sheet length STEP number of the sheet Sa in the conveying direction can be calculated as 200+140=340 STEPS. The fixed default value (an example of a first rotation amount) referred to as 200 STEPS of the length X is stored in the NVRAM 104 in advance. The CPU 101 read and use 200 STEPS of the length X from the NVRAM 104. When the sheet length STEP number is calculated in this manner, the cutting position CPa is calculated by the sheet length STEP number/2. Specifically, the cutting position CPa is 170 STEPS. The length X is 200 STEPS, and thus, the cutting position CPa is at a position at 30 STEPS (=200−170) on the upstream side from the detection position of the sheet detection sensor SE4. Furthermore, a length Y from the detection position of the sheet detection sensor SE4 to the cutter position B is 40 STEPS which is a fixed default value. The fixed default value of 40 STEPS of the length Y (an example of a third rotation amount) is stored in advance in the NVRAM 104. Therefore, if the sheet Sa is conveyed to the downstream side by moving the cutting position CPa by 70 STEPS (=30+40) from the current position where the discharge sensor SE3 is in the OFF state, the cutting position CPa reaches the cutter position B. That is, Formula (2) represents the number of STEPS since the trailing end of the sheet S reaches the detection position of the discharge sensor SE3 until the cutting position CP of the sheet S reaches the cutter position B.

Returning to FIG. 20, next, the CPU 101 waits until the discharge motor 109 is rotatably driven by the number of STEPS calculated in S234 (S236: NO), and if the discharge motor 109 is rotatably driven for the number of STEPS (S236: YES), the CPU 101 ends the sheet conveying process to cutter position. Thereafter, the CPU 101 proceeds the process to S220 of FIG. 19.

In S220, the CPU 101 stops the discharge motor 109. Then, the CPU 101 executes a sheet cutting process (S222).

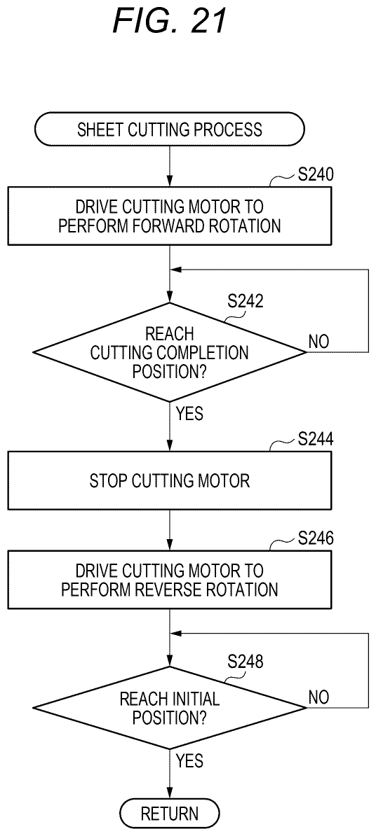

FIG. 21 shows a detailed procedure of the sheet cutting process. In FIG. 21, first, the CPU 101 drives the cutting motor 106 to perform the forward rotation (S240). By driving the cutting motor 106 to perform the forward rotation, the moving blade 15 starts to move from an initial position toward the cutting completion position (the position indicated by the dashed line in FIG. 2). Then, the CPU 101 waits until the moving blade 15 of the cutter 10 reaches the cutting completion position (the position indicated by the dashed line in FIG. 2) (S242: NO), and if the moving blade 15 reaches the cutting completion position (S242: YES), the CPU 101 proceeds the process to S244. The CPU 101 may count the number of rotations of the cutting motor 106 based on the output signal from the encoder attached to the cutting motor 106, and determine based on the count value whether the moving blade 15 reaches the cutting completion position from the initial position (the position indicated by the solid line in FIG. 2).

In S244, the CPU 101 stops the cutting motor 106. Thereafter, the CPU 101 drives the cutting motor 106 to perform the reverse rotation (S246). Then, the CPU 101 waits until the moving blade 15 reaches the initial position (S248: NO), and if the moving blade 15 reaches the initial position (S248: YES), the CPU 101 ends the sheet cutting process. Thereafter, the CPU 101 proceeds the process to S224 of FIG. 19.

When the CPU 101 executes the sheet cutting process, the sheet S is stopped in a state where the cutting position CP reaches the cutter position B. Therefore, if the sheet cutting process is executed when the sheet S is stopped in this state, as shown in FIG. 23B, even if the sheet S shrinks to become the sheet Sa, the sheet Sa is cut into two sheets at the center (cutting position CPa) in the conveying direction.

In S224 of FIG. 19, the CPU 101 drives the discharge motor 109 to perform the forward rotation, and stops the discharge motor 109 after a predetermined time elapses. Accordingly, the sheet S divided into two equal parts is discharged to the discharge tray 22. Therefore, the “predetermined time” is the time taken for the sheet on the upstream side in the conveying direction of the two equal parts of the sheet S to be discharged from the first discharge path 201A to the discharge tray 22.

Next, the CPU 101 determines whether a next sheet is to be printed in the job being executed (S226). If the next sheet is to be printed (S226: YES), the CPU 101 returns the process to S202 and continues the processes of S202 and the subsequent steps. On the other hand, if the next sheet is not printed (S226: NO), the CPU 101 stops the main motor 108 (S228), and then ends the sheet printing and cutting process.

As described above, the printer 1 of the present embodiment includes the device main body 2 including the conveying path 201 of the sheet S; the fixing unit 6 including the heating roller 61 and the pressure roller 62 in which the nip N is formed between the heating roller 61 and the pressure roller 62, and configured to fix an image formed on the sheet S onto the sheet S; the conveying rollers 35, 36, and 85 to 87 including the first discharge roller 85 located at the downstream side of the fixing unit 6 in the conveying direction of the sheet S along the conveying path 201, and configured to convey the sheet S, and the second discharge roller 86 located at the downstream side of the first discharge roller 85 in the conveying direction, and configured to discharge the sheet S conveyed by the first discharge roller 85 to the outside of the device main body 2; the cutter 10 located at the cutter position B, which is a position between the first discharge roller 85 and the second discharge roller 86 in the conveying direction, and configured to cut the sheet S in the cutting direction intersecting the conveying direction; the sheet detection sensor SE4 configured to detect whether the sheet S is present at the first detection position between the first discharge roller 85 and the second discharge roller 86 in the conveying direction; the discharge sensor SE3 configured to detect whether the sheet S is present at the second detection position between the first discharge roller 85 and the fixing unit 6 in the conveying direction; and the CPU 101.

The CPU 101 executes the conveying process (S218, S220) of conveying the sheet S along the conveying path 201 by using the conveying rollers 35, 36, and 85 to 87, correcting the rotation amount of the first discharge roller 85 and the second discharge roller 86 for the ideal cutting position CP of the sheet S passing through a part of the conveying path 201 to reach the cutter position B based on the detection results of the sheet detection sensor SE4 and the discharge sensor SE3, rotating the first discharge roller 85 and the second discharge roller 86 by the corrected rotation amount, and then stopping the first discharge roller 85 and the second discharge roller 86, and the cutting process (S222) of cutting the sheet S in the cutting direction by using the cutter 10 after the conveying process.

Accordingly, in the printer 1 of the present embodiment, the rotation amount of the first discharge roller 85 and the second discharge roller 86 for the ideal cutting position CP of the sheet S to reach the cutter position B is corrected based on the detection results of the sheet detection sensor SE4 and the discharge sensor SE3, the first discharge roller 85 and the second discharge roller 86 rotate by the corrected rotation amount and then stop, and the sheet Sa is cut at this stop position, and thus, even if the sheet S shrinks due to heat applied to the sheet S by the fixing unit 6, the sheet Sa can be cut at the desired cutting position.

Incidentally, in the present embodiment, the heating roller 61 is an example of the “heating rotor”. The pressure roller 62 is an example of the “pressure rotor”. The CPU 101 is an example of the “controller”. The sheet detection sensor SE4 is an example of a “first sensor”. The discharge sensor SE3 is an example of the “second sensor”.

In the conveying process, the CPU 101 acquires a first timing when the leading end of the sheet S reaches the first detection position based on the detection result of the sheet detection sensor SE4 (S212), acquires the second timing when the trailing end of the sheet S reaches the second detection position based on the detection result of the discharge sensor SE3 (S216), and corrects the rotation amount of the first discharge roller 85 and the second discharge roller 86 based on the acquired first timing and second timing.

Accordingly, the sheet length of the sheet S is measured, and thus, even if the sheet S shrinks due to the heat applied to the sheet S by the fixing unit 6, the sheet Sa can be cut at the desired cutting position.

The printer 1 further includes the main motor 108 that rotationally drives any one of the heating roller 61 or the pressure roller 62 included in the fixing unit 6, and the discharge motor 109 that rotationally drives the first discharge roller 85 and the second discharge roller 86. The CPU 101 controls the main motor 108 and the discharge motor 109 such that the rotation speed of the discharge motor 109 is higher than the rotation speed of the main motor 108.

Accordingly, even if flexing occurs when the sheet S passes through the fixing unit 6, the conveying speed of the sheet S is increased by the first discharge roller 85 and the second discharge roller 86, and thus, the flexing of the sheet S can be eliminated.

The printer 1 further includes the NVRAM 104. The NVRAM 104 stores in advance, as the first rotation amount, the rotation amount of the first discharge roller 85 and the second discharge roller 86 required to convey the sheet S from the first detection position of the sheet detection sensor SE4 to the second detection position of the discharge sensor SE3, and in the conveying process, the CPU 101 acquires, as the second rotation amount, the rotation amount of the first discharge roller 85 and the second discharge roller 86 required from the first timing to the second timing, acquires the sheet length of the sheet Sa in the conveying direction after passing through the fixing unit 6 based on the first rotation amount and the second rotation amount, determines the cutting position on the sheet S based on the acquired sheet length, and stops the rotation driving of the discharge motor 109. Incidentally, the NVRAM 104 is an example of a “memory”.

Accordingly, it is unnecessary to measure a fixed value, and the sheet length of the sheet Sa in the conveying direction can be acquired more accurately.

After acquiring the second timing, the CPU 101 controls the discharge motor 109 to perform the rotation driving until the determined cutting position CPa on the sheet Sa reaches the cutter position B.

Accordingly, the conveying of the sheet Sa can be stopped in a state where the determined cutting position CPa on the sheet Sa reaches the cutter position B.

The discharge motor 109 is a stepping motor, and the CPU 101 controls a stop timing of the discharge motor 109 by the number of steps of the stepping motor.

Accordingly, the stop timing of the discharge motor can be controlled by a simple method of counting the number of steps of the stepping motor 109.

The sheet detection sensor SE4 is located at the upstream side of the cutter position B in the conveying direction, the first rotation amount is indicated by the number of steps of the stepping motor, the NVRAM 104 stores in advance, as the third rotation amount, the rotation amount of the first discharge roller 85 and the second discharge roller 86 required to convey the sheet S from the first detection position of the sheet detection sensor SE4 to the cutter position B, the rotation amount being indicated by the number of steps of the stepping motor, and in the conveying process, the CPU 101 acquires the second rotation amount by the number of steps of the stepping motor, and after acquiring the second timing, controls the discharge motor 109 to perform the rotation driving by {first rotation amount−(first rotation amount+second rotation amount)/2+third rotation amount}.

Accordingly, even if the sheet S shrinks by the heat applied to the sheet S by the fixing unit 6, the sheet Sa can be accurately cut at the center in the sheet conveying direction by a simple method of counting the number of steps of the stepping motor.

The device main body 2 is a part of the conveying path 201, and includes the first discharge path 201A for discharging the sheet S to the outside of the device main body 2 through the cutter position B, the second discharge path 201B which is a part of the conveying path 201 and is a path different from the first discharge path 201A and for discharging the sheet S to the outside of the device main body 2, and the flapper 88 for guiding the sheet S to any one of the first discharge path 201A or the second discharge path 201B. Then, the CPU 101 accepts the printing job including information on whether cutting of the sheet by the cutter 10 is necessary, moves the position of the flapper 88 to guide the sheet S to the first discharge path 201A if it is determined based on the printing job that the cutting of the sheet is necessary, and moves the position of the flapper 88 to guide the sheet S to the second discharge path 201B if it is determined based on the printing job that the cutting of the sheet is unnecessary.

Accordingly, if the cutting of the sheet S is necessary, the sheet S is guided to the first discharge path 201A by the flapper 88, and if the cutting of the sheet S is unnecessary, the sheet S is guided to the second discharge path 201B by the flapper 88, which is convenient.

### Fourth Embodiment

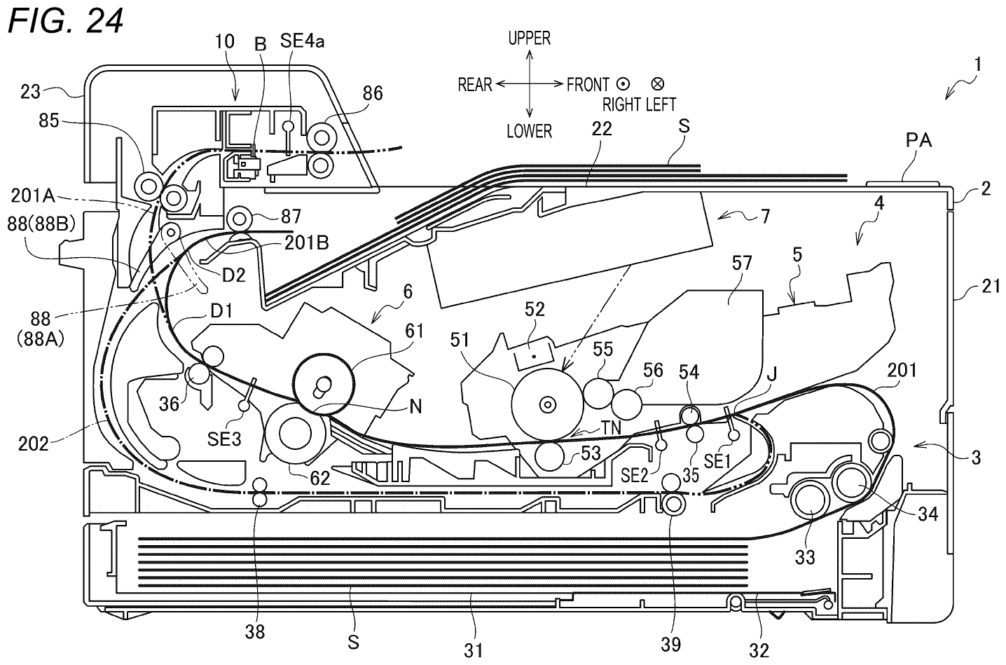

Next, a fourth embodiment of the present application will be described. The present embodiment is configured by changing the installation position of the sheet detection sensor SE4 described in the third embodiment, and thus, the changed parts will be mainly described and descriptions of other parts will be omitted as appropriate. Hardware of the present embodiment uses almost all of the hardware described in FIGS. 1 to 3 and FIG. 17, but in order to clarify an installation position of a sheet detection sensor SE4a in the present embodiment, a cross-sectional view in FIG. 24 is used instead of FIG. 1 and FIG. 17. Here, in FIG. 24, the same members as those in FIG. 1 and FIG. 17 are denoted by the same reference numerals.

The sheet detection sensor SE4 in FIG. 17 is installed between the first discharge roller 85 and the cutter position B, whereas the sheet detection sensor SE4a in FIG. 24 is installed between the cutter position B and the second discharge roller 86. It is necessary to change a part of the sheet conveying process to cutter position in FIG. 20 based on a difference in the installation position.

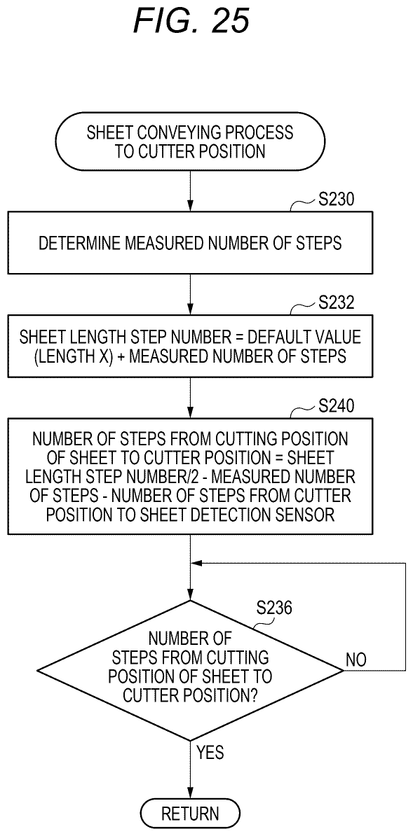

FIG. 25 shows a detailed procedure of a sheet conveying process to cutter position executed by the CPU 101 of the present embodiment. In FIG. 25, the same process as in that in FIG. 20 is denoted by the same step number, and a description of the process is omitted as appropriate.

In FIG. 25, the CPU 101 calculates the number of STEPS from the cutting position CP of the sheet S to the cutter position B in the conveying path 201 and the first discharge path 201A based on the following Formula (3) (S240).

$$Sheet length STEP \text{number/} 2 - measured number of STEPS - number of STEPS from cutter position B to sheet detection s ensor SE 4 \qquad ( 3 )$$

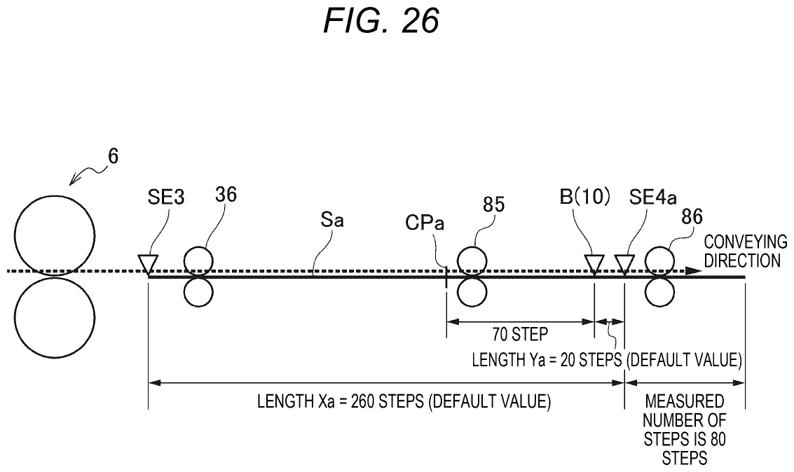

FIG. 26 is a diagram illustrating the process of S240 and shows a state where the trailing end of the sheet Sa reaches the detection position of the discharge sensor SE3. At this time, the measured number of STEPS determined in S230 is 80 STEPS. That is, the number of STEPS since the sheet detection sensor SE4a detects the leading end of the sheet Sa until the discharge sensor SE3 detects the trailing end of the sheet Sa is 80 STEPS. A length Xa from the discharge sensor SE3 to the sheet detection sensor SE4a is 260 STEPS which is a fixed default value, and thus, the sheet length STEP number of the sheet Sa in the conveying direction can be calculated as 260+80=340 STEPS. For example, when the length Xa is stored in advance in the NVRAM 104, the length Xa may be read and used. When the sheet length STEP number is calculated in this manner, the cutting position CPa is calculated by the sheet length STEP number/2. Specifically, the cutting position CPa is 170 STEPS. The length Xa is 260 STEPS, and thus, the cutting position CPa is at a position at 90 STEPS (=260−170) on the upstream side from the detection position of the sheet detection sensor SE4a. Furthermore, a length Ya from the cutter position B to the detection position of the sheet detection sensor SE4a is 20 STEPS which is a fixed default value. Therefore, if the sheet Sa is conveyed by moving the cutting position CPa from the current position (=170 STEPS) to the downstream side by 70 STEPS (=90−20), the cutting position CPa reaches the cutter position B. That is, Formula (3) represents the number of STEPS since the trailing end of the sheet Sa reaches the detection position of the discharge sensor SE3 until the cutting position CPa of the sheet Sa reaches the cutter position B.

As described above, in the printer 1 of the present embodiment, the sheet detection sensor SE4a is located at the downstream side of the cutter position B in the conveying direction, the first rotation amount is indicated by the number of steps of the stepping motor, and the NVRAM 104 stores in advance, as the third rotation amount, the rotation amount of the first discharge roller 85 and the second discharge roller 86 required to convey the sheet S from the cutter position B to a first detection position of the sheet detection sensor SE4a, the rotation amount being indicated by the number of steps of the stepping motor. In the conveying process, the CPU 101 acquires the second rotation amount by the number of steps of the stepping motor, and after acquiring the second timing, controls the discharge motor 109 to perform the rotation driving by {first rotation amount−(first rotation amount+second rotation amount)/2−third rotation amount}. Incidentally, the sheet detection sensor SE4a is an example of the “first sensor”.

Accordingly, even if the sheet S shrinks by the heat applied to the sheet S by the fixing unit 6, the sheet Sa can be accurately cut at the center in the sheet conveying direction by a simple method of counting the number of steps of the stepping motor.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
(1) In the embodiments, the detection positions where the pre-registration sensor SE1, the post-registration sensor SE2, the discharge sensor SE3, and the sheet detection sensor SE4 detect the passage of the sheet S substantially coincide with the installation positions of the sensors, but the present invention is not limited thereto, and a sensor in which an installation position of the sensor and the detection position of the sheet S are separated may be used.
(2) In the first and second embodiments, the sheet detection sensor SE4 is disposed between the cutter position B and the second discharge roller 86, but the present invention is not limited thereto, and the sheet detection sensor SE4 may be disposed between the first discharge roller 85 and the cutter position B.
(3) In the embodiments, the monochrome laser printer 1 is described as an example of the image forming device, but the present invention is not limited thereto, and may use a color laser printer.
(4) In the embodiments, the sheet S is cut into two equal parts, but the present invention is not limited thereto, and the sheet S may be cut into, for example, three equal parts.
(5) In the embodiments, when the printing job is received from the outside of the printer 1, the printing job is received via the communication I/F 130, but the present invention is not limited thereto, and the printing job may be received via, for example, a USB interface.
(6) In the embodiments, the sheet detection sensor SE4 is used to detect the opening and closing of the cover 23 and to detect a sheet, but separate detection sensors may be used.
(7) In the embodiments, even after the predetermined time since starting the driving of the discharge motor 109 elapses, the sheet detection sensor SE4 determines that a jam occurs if the sheet is not detected, but the sheet detection sensor SE4 may be configured not to perform such a determination. For example, the output of the sheet detection sensor SE4 may be used only to convey the sheet S until the cutting position CP of the sheet S reaches the cutter position B. Conversely, instead of using the output of the sheet detection sensor SE4 to convey the sheet S until the cutting position CP of the sheet S reaches the cutter position B, when the sheet detection sensor SE4 does not detect the sheet even after the predetermined time since starting the driving of the discharge motor 109 elapses, the sheet detection sensor SE4 may be used only to determine that a jam occurs.
(8) In the embodiments, the printer 1 is configured to cut the sheet S having the A4 size and the sheet S having the letter size at the center of the sheet, but the sheet S having the A4 size may not be cut, and only the sheet S having the letter size may be cut, for example. In this case, the length of the conveying path 201 from the nip N to the cutter position B in FIG. 1 and the length of the conveying path 201 from the nip of the roller 36 to the cutter position B may be designed to be longer than half (139.7 mm) the dimension (279.4 mm) of the letter size in the conveying direction. Furthermore, a sheet having a size larger than the A4 size may be cut.
(9) In the embodiments, the cutter 10 includes the moving blade 15 and the fixing blade 13, but as long as the sheet S can be cut, the shape and type of the cutter are not important. For example, a configuration that cuts the sheet by dropping the blade long in the cutting direction to the sheet S, or a scissor may be used.

What is claimed is:

1. An image forming device comprising:
a device main body including a conveying path of a sheet;
a fixing unit configured to fix an image formed on the sheet onto the sheet, the fixing unit including:
a heating rotor; and
a pressure rotor in which a nip is formed between the heating rotor and the pressure rotor,;
a first discharge roller located at a downstream side of the fixing unit in a conveying direction of the sheet along the conveying path, and configured to convey the sheet;
a second discharge roller located at a downstream side of the first discharge roller in the conveying direction, and configured to discharge the sheet conveyed by the first discharge roller to an outside of the device main body;
a cutter located at a cutter position and configured to cut the sheet in a cutting direction intersecting the conveying direction, the cutter position being a position between the first discharge roller and the second discharge roller in the conveying direction; and
a first sensor configured to detect whether the sheet is present at a first detection position between the first discharge roller and the second discharge roller in the conveying direction.

2. The image forming device according to claim 1, further comprising:
a controller,
wherein the controller is configured to execute:
a conveying process of driving, based on an output of the first sensor, the first discharge roller and the second discharge roller with a driving amount required to convey the sheet from a position where a leading end of the sheet reaches the first detection position to a position where a cutting position of the sheet reaches the cutter position, and then stopping conveying the sheet, and
a cutting process of cutting the sheet in the cutting direction by using the cutter, after the conveying process.

3. The image forming device according to claim 2,
wherein the controller is configured to execute a driving amount acquiring process of receiving printing data including a sheet size of the sheet, and of acquiring the driving amount based on the sheet size included in the received printing data, and
in the conveying process, the controller is configured to drive the first discharge roller and the second discharge roller with the driving amount acquired by the driving amount acquiring process, and then stop conveying the sheet.

4. The image forming device according to claim 2, further comprising:
a second sensor configured to detect whether the sheet is present at a second detection position that is an upstream side of the first sensor in the conveying direction,
wherein the controller is configured to execute:
a sheet length acquiring process of detecting, based on an output of the second sensor, that a trailing end of the sheet reaches the second detection position after the leading end of the sheet reaches the second detection position, and of acquiring a sheet length of the sheet in the conveying direction based on the detected leading end and trailing end of the sheet; and
a driving amount acquiring process of acquiring the driving amount based on the sheet length acquired by the sheet length acquiring process, and
in the conveying process, the controller is configured to drive the first discharge roller and the second discharge roller with the driving amount acquired by the driving amount acquiring process, and then stop conveying the sheet.

5. The image forming device according to claim 2, further comprising:
a discharge motor configured to drive the first discharge roller and the second discharge roller,
wherein, during the conveying process, in a case where the first sensor does not detect the sheet after a predetermined time since starting driving of the discharge motor elapses, the controller stops the driving of the discharge motor.

6. The image forming device according to claim 5, further comprising:
a main motor configured to rotatably drive any one of the heating rotor or the pressure rotor,
wherein, during the conveying process, in a case where the first sensor does not detect the sheet after the predetermined time since starting the driving of the discharge motor elapses, the controller stops the driving of the main motor.

7. The image forming device according to claim 2, further comprising:
a discharge motor configured to drive the first discharge roller and the second discharge roller,
wherein, after the cutting process, the controller is configured to execute a discharge process of driving the first discharge roller and the second discharge roller to discharge the cut sheet to the outside of the device main body, and
during the discharge process, in a case where the first sensor detects the sheet after a predetermined time since starting driving of the discharge motor elapses, the controller stops the driving of the discharge motor.

8. The image forming device according to claim 7,
wherein the cutter includes a blade configured to cut the sheet, and a cutting motor configured to move the blade in the cutting direction, and
during the cutting process, in a case where the cutting motor drives and the discharge motor does not drive, and in a case where the first sensor changes from a state where the sheet is detected to a state where the sheet is not detected, the controller stops the driving of the cutting motor.

9. The image forming device according to claim 1,
wherein the first sensor is configured to detect whether the sheet is present at a detection position between the cutter and the second discharge roller.

10. The image forming device according to claim 1, further comprising:
a controller; and
a cover configured to be opened and closed freely to cover the conveying path between the first discharge roller and the second discharge roller,
wherein the first sensor is configured to:
in a case where the cover is in an open state or in a case where the cover is in a closed state and the sheet is detected, output a first signal; and
in a case where the cover is in the closed state and the sheet is not detected, output a second signal, and
in a case where the sheet is not conveyed by the first discharge roller and the second discharge roller in a state where the first signal is output from the first sensor, the controller determines that the cover is in the open state.

11. The image forming device according to claim 1, further comprising:
a controller; and
a third discharge roller configured to discharge the sheet to the outside of the device main body, the third discharge roller being located on a discharge path branched from the conveying path between the fixing unit and the first discharge roller, and the third discharge roller being located at a position shorter than a length of the conveying path from the fixing unit to the second discharge roller,
wherein the controller is configured to:
receive printing data including cutting information indicating whether the sheet is cut; and
in a case where the cutting information included in the received printing data indicates that the sheet is not cut, cause the third discharge roller to convey the sheet and discharge the sheet without being cut from the device main body to the outside.

12. The image forming device according to claim 11, further comprising:
a flapper configured to be switched between a first position for guiding the sheet toward the first discharge roller and a second position for guiding the sheet toward the third discharge roller,
wherein the controller is configured to:
in a case where the cutting information indicates that the sheet is cut, switch the flapper to the first position, after a leading end of the sheet leaves the fixing unit and before the leading end of the sheet reaches the flapper; and
in a case where the cutting information indicates that the sheet is not cut, switch the flapper to the second position, after the leading end of the sheet leaves the fixing unit and before the leading end of the sheet reaches the flapper.

13. The image forming device according to claim 1,
wherein a length of the conveying path from the fixing unit to the cutter is longer than half a sheet length of the cuttable sheet in the conveying direction.

14. The image forming device according to claim 2, further comprising:
a discharge motor configured to drive the first discharge roller;
a roller located between the first discharge roller and the fixing unit; and
a main motor configured to drive the roller and the fixing unit,
wherein a length of the conveying path from the roller to the cutter is longer than half a sheet length of the cuttable sheet in the conveying direction, and
the controller is configured to keep the main motor driven during the cutting process.

15. The image forming device according to claim 1, further comprising:
an image forming unit located at an upstream side of the fixing unit in the conveying direction and configured to form an image on the sheet, the image forming unit including:
a photosensitive drum;
a developing roller configured to supply toner to the photosensitive drum; and
a transfer roller configured to transfer a toner image formed on the photosensitive drum to the sheet.

16. The image forming device according to claim 1, further comprising:
a plurality of conveying rollers including the first discharge roller and the second discharge roller;
a second sensor configured to detect whether the sheet is present at a second detection position between the first discharge roller and the fixing unit in the conveying direction; and
a controller,
wherein the controller is configured to execute:
a conveying process of conveying the sheet along the conveying path by using the plurality of conveying rollers, the conveying process includes correcting a rotation amount of the first discharge roller and the second discharge roller for an ideal cutting position of the sheet passing through a part of the conveying path to reach the cutter position based on detection results of the first sensor and the second sensor, rotating the first discharge roller and the second discharge roller by the corrected rotation amount, and then stopping the first discharge roller and the second discharge roller; and
a cutting process of cutting the sheet in the cutting direction by using the cutter, after the conveying process.

17. The image forming device according to claim 16,
wherein, in the conveying process, the controller is configured to acquire a first timing when a leading end of the sheet reaches the first detection position based on the detection result of the first sensor, acquire a second timing when a trailing end of the sheet reaches the second detection position based on the detection result of the second sensor, and correct the rotation amount of the first discharge roller and the second discharge roller based on the acquired first timing and second timing.

18. The image forming device according to claim 17, further comprising:
a main motor configured to rotatably drive any one of the heating rotor or the pressure rotor included in the fixing unit; and
a discharge motor configured to rotatably drive the first discharge roller and the second discharge roller,
wherein the controller is configured to control the main motor and the discharge motor such that a rotation speed of the discharge motor is higher than a rotation speed of the main motor.

19. The image forming device according to claim 18, further comprising:
a memory,
wherein the memory is configured to store in advance, as a first rotation amount, a rotation amount of the first discharge roller and the second discharge roller required to convey the sheet from the second detection position of the second sensor to the first detection position of the first sensor, and
the controller is configured to, in the conveying process:
acquire, as a second rotation amount, a rotation amount of the first discharge roller and the second discharge roller required from the first timing to the second timing;
acquire a sheet length of the sheet in the conveying direction after passing through the fixing unit, based on the first rotation amount and the second rotation amount; and
determine a cutting position on the sheet based on the acquired sheet length, and stop rotation driving of the discharge motor.

20. The image forming device according to claim 19,
wherein, after acquiring the second timing, the controller is configured to control the discharge motor to perform the rotation driving until the determined cutting position on the sheet reaches the cutter position.
